(19) United States
(12) Patent Application Publication
(10) Pub. No.: US 2024/0288846 A1
(43) Pub. Date: Aug. 29, 2024

(54) MANAGEMENT SYSTEM, MANAGEMENT METHOD, AND RECORDING MEDIUM

(71) Applicant: Panasonic Intellectual Property Corporation of America, Torrance, CA (US)

(72) Inventor: Yuko TSUSAKA, Kyoto (JP)

(73) Assignee: PANASONIC INTELLECTUAL PROPERTY CORPORATION OF AMERICA, Torrance, CA (US)

(21) Appl. No.: 18/658,615

(22) Filed: May 8, 2024

Related U.S. Application Data
(63) Continuation of application No. PCT/JP2022/034966, filed on Sep. 20, 2022.

(30) Foreign Application Priority Data
Nov. 16, 2021 (JP) 2021-186540

(51) Int. Cl. G05B 19/402; G01C 21/00

(52) U.S. Cl. CPC G05B 19/402; G01C 21/383; G05B 2219/31396

(57) ABSTRACT

A management system includes: a position sensor that obtains a positional relationship between itself and an object; a floor map generator that generates a floor map based on the position relationship; a self position calculator that calculates a self position; a marker identifier that identifies a marker; an asset information obtainer that obtains asset information related to an asset to which the marker is attached; an asset position calculator that calculates a position of the asset on the floor map based on the positional relationship, the self position, and a relative position of the marker; a database in which the floor map, the asset information, and the position information of the asset are associated with each other; and an asset management map generator that generates an asset management map based on the database.

### CROSS REFERENCE TO RELATED APPLICATIONS

This is a continuation application of PCT International Application No. PCT/JP2022/034966 filed on Sep. 20, 2022, designating the United States of America, which is based on and claims priority of Japanese Patent Application No. 2021-186540 filed on Nov. 16, 2021. The entire disclosures of the above-identified applications, including the specifications, drawings and claims are incorporated herein by reference in their entirety.

### FIELD

The present disclosure relates to a management system, a management method, and a recording medium.

### BACKGROUND

Recent years have seen demand for technology capable of making it easy to centrally manage assets such as control devices placed in buildings and machines controlled by such control devices. PTL 1, for example, discloses a management device that stores machine information on machine tools installed in a factory in association with position information, presents a layout diagram of the machine tools in the factory based on the stored information, and outputs the machine information of a machine tool selected in the presented layout diagram.

### CITATION LIST

### Patent Literature

PTL 1: Japanese Unexamined Patent Application Publication No. 2020-016998

### SUMMARY

### Technical Problem

However, the management device according to PTL 1 obtains the machine information on machine tools connected to a network, but does not obtain the machine information for machine tools not connected to the network, and it is therefore difficult to say that the machine tools in the factory are being centrally managed in a comprehensive manner. Furthermore, when newly installing or relocating a machine tool, the management device according to PTL 1 requires a user to manually enter the position information of the machine tool, which is cumbersome.

Accordingly, the present disclosure provides a management system, a management method, and a recording medium which make it possible to centrally manage assets installed in a building with ease.

### Solution to Problem

To solve the above-described problem, a management system according to one aspect of the present disclosure is a management system that centrally manages a plurality of assets provided in a building. The management system includes: a sensor that detects an object in a vicinity of the sensor and obtains a positional relationship between the sensor and the object; a floor map generator that, based on the positional relationship obtained by the sensor, generates a floor map indicating a predetermined floor in the building; a self position calculator that calculates a self position of the sensor on the floor map generated by the floor map generator; a marker identifier that identifies a marker present in a vicinity of the sensor; an asset information obtainer that, based on the marker identified by the marker identifier, obtains asset information related to an asset to which the marker is attached; an asset position calculator that, based on the positional relationship, the self position, and a relative position of the marker with respect to the sensor, calculates a position of the asset on the floor map; a database in which the floor map, the asset information, and the position information indicating the position of the asset are registered in association with each other; an asset management map generator that, based on the database, generates an asset management map in which the position of the asset on the floor map is indicated, and in which the position of the asset indicated and the asset information are associated with each other; a management information generator that generates management information related to management of the asset; and a network connection determiner that determines whether the asset has a network connection function by using a network diagnostic tool. The management information generator obtains a determination result from the network connection determiner, generates the management information based on the determination result obtained; and registers the management information generated in the database in association with the asset management map.

Additionally, a management method according to one aspect of the present disclosure is a management method for centrally managing a plurality of assets provided in a building. The management method includes: detecting an object in a vicinity of a sensor and obtaining a positional relationship between the sensor and the object; generating a floor map indicating a predetermined floor in the building, based on the positional relationship obtained in the obtaining; calculating a self position of the sensor on the floor map generated in the generating; identifying a marker present in a vicinity of the sensor; obtaining asset information related to an asset to which the marker is attached, based on the marker identified in the identifying; calculating a position of the asset on the floor map, based on a relative position of the marker with respect to the sensor; registering the floor map, the asset information, and position information indicating a position of the asset in a database in association with each other; generating an asset management map in which the position of the asset on the floor map is indicated, and in which the position of the asset indicated and the asset information are associated with each other, based on the database; generating management information related to management of the asset; and determining whether the asset has a network connection function by using a network diagnostic tool. The generating of the management information includes obtaining a determination result of the determining, generating the management information based on the determination result obtained, and registering the management information generated in the database in association with the asset management map.

Additionally, a recording medium according to one aspect of the present disclosure is a non-transitory computer-readable recording medium having recorded thereon a program for causing a computer to execute the management method described above.

### Advantageous Effects

According to the present disclosure, a management system, a management method, and a recording medium can be provided which make it possible to centrally manage assets installed in a building with ease.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an overview of a management system according to Embodiment 1.

FIG. 2 is a block diagram illustrating an example of the functional configuration of the management system according to Embodiment 1.

FIG. 3 is a perspective view illustrating an asset management map generation device according to Embodiment 1 at an angle from above.

FIG. 4 is a front view illustrating the asset management map generation device according to Embodiment 1 from the front.

FIG. 5 is a flowchart illustrating an example of operations by the management system according to Embodiment 1.

FIG. 6 is a diagram illustrating an image presented in a presenter of an information terminal.

FIG. 7 is a diagram illustrating an example of a database.

FIG. 8 is a diagram illustrating an example of map information.

FIG. 9 is a diagram illustrating an example of a floor map.

FIG. 10 is a diagram illustrating an example of an asset management map.

FIG. 11 is a diagram illustrating an example of area division in the asset management map.

FIG. 12 is a diagram illustrating another example of area division in the asset management map.

FIG. 13 is a diagram illustrating an example of the display of the asset management map and management information.

FIG. 14 is a block diagram illustrating an example of the functional configuration of the management system according to Embodiment 2.

FIG. 15 is a front view illustrating the asset management map generation device according to Embodiment 2 from the front.

FIG. 16 is a block diagram illustrating an example of the functional configuration of the management system according to Embodiment 3.

FIG. 17 is a flowchart illustrating an example of operations by the management system according to Embodiment 3.

FIG. 18 is a diagram illustrating an example of terminal position information.

FIG. 19 is a diagram illustrating an example of the display of inspection information.

### DESCRIPTION OF EMBODIMENTS

### Findings Leading to Present Disclosure

Recent years have seen demand for technology capable of making it easy to centrally manage assets such as control devices placed in buildings and machines controlled by such control devices.

For example, many assets are installed in structures such as factories or buildings, including industrial machinery such as machine tools or robots and control devices for controlling such industrial machinery, facility equipment such as elevators, entry gates, or air conditioning devices and control devices for controlling such equipment, information processing devices such as personal computers, and the like. If the information of these assets is not centrally managed, when a facility manager or worker wishes to obtain detailed information on an asset installed in a building, that person must go to the place where the asset is installed, confirm the product name, model number, and the like of the asset, and then search for the product name, the model number, or the like on the Internet or the like.

Additionally, the need to confirm and manage the presence or absence of vulnerabilities and the connection relationships among assets to understand the states of assets that can be connected to networks is now considered essential as a cybersecurity measure. For example, if an asset is infected with a virus and urgent action such as blocking the asset from the network is required, a user may not be able to take appropriate measures unless they know where the asset is installed and what connection relationships that asset has with other assets. It is therefore desirable to centrally manage asset information and position information not only for assets that are connected to devices outside the building through wide-area network communication such as the Internet, but also for assets which are connected to each other within the building.

PTL 1, for example, discloses an industrial machine management device that centrally manages machine information of industrial machines including various types of machine tools or robots installed in a factory. This management device presents, to a user, a factory layout diagram of the industrial machines being centrally managed, and when an icon of an industrial machine displayed in the factory layout diagram is selected by the user, outputs machine information associated with the selected icon.

However, the management device disclosed in PTL 1 obtains the machine information on machine tools connected to a network, but does not obtain the machine information for machine tools not connected to the network, and it is therefore difficult to say that the machine tools in the factory are being centrally managed in a comprehensive manner. Furthermore, when newly installing or relocating a machine tool, the management device according to PTL 1 requires a user to manually enter the position information of the machine tool, which is cumbersome.

A control device has been disclosed which, for example, has a state monitoring screen for monitoring the operating states of a plurality of injection molding machines installed in a factory as a means for understanding the states of assets (PTL 2: Japanese Unexamined Patent Application Publication No. 2004-155053). This control device displays a factory area indicating at least one factory in the state monitoring screen, and icons corresponding to the injection molding machines are displayed in the factory area based on the actual arrangement relationship of the injection molding machines within the factory. Then, when a user selects an icon, operating information indicating the operating state of the injection molding machine corresponding to the icon is displayed.

However, while the control device disclosed in PTL 2 can monitor the operating states of injection molding machines connected to a network, the control device cannot monitor the operating states of industrial machines, such as injection molding machines, not connected to the network. In addition, although various industrial machines other than injection molding machines, control devices for the industrial machines, personal computers for work, and the like are also installed in the factory, the control device according to PTL 2 can only manage the information of the injection molding machines.

Furthermore, a network terminal position information obtainment method has been disclosed which is capable of automatically obtaining position information of a terminal device connected to a network as, for example, a means for automatically ascertaining the position of an asset connected to a network (PTL 3: Japanese Patent Application Publication No. 2007-318432). According to this method, a table is prepared in advance which associates a port of a switching hub with the position information of the switching hub, an access point, or a terminal device connected to the port. Then, path information including the port and the Media Access Control (MAC) address of the terminal device connected to the port is read sequentially from the memory of the upstream-side switching hub to the downstream-side switching hub using Simple Network Management Protocol (SNMP). In this manner, the current position of the terminal device is derived by sequentially tracking the terminal device connected to each port and referring to the table.

However, the method disclosed in PTL 3 can only obtain the position information of a terminal device connected to a switching hub that supports SNMP, and therefore cannot be applied to terminal devices that do not support SNMP.

After diligently examining the issues described above, the inventor of the present disclosure arrived at a technique in which information on an asset disposed in a space is obtained while generating a map of the space in which the asset is disposed, and the position of the asset in the map is stored in association with the information on the asset. This makes it possible to manage the information of assets and positions of assets disposed in a building in association with a map regardless of whether there is a network connection.

Therefore, according to the present disclosure, assets disposed in a building can be centrally managed with ease.

### Overview of the Present Disclosure

An overview of one aspect of the present disclosure is as follows.

A management system according to one aspect of the present disclosure is a management system that centrally manages a plurality of assets provided in a building. The management system includes: a sensor that detects an object in a vicinity of the sensor and obtains a positional relationship between the sensor and the object; a floor map generator that, based on the positional relationship obtained by the sensor, generates a floor map indicating a predetermined floor in the building; a self position calculator that calculates a self position of the sensor on the floor map generated by the floor map generator; a marker identifier that identifies a marker present in a vicinity of the sensor; an asset information obtainer that, based on the marker identified by the marker identifier, obtains asset information related to an asset to which the marker is attached; an asset position calculator that, based on the positional relationship, the self position, and a relative position of the marker with respect to the sensor, calculates a position of the asset on the floor map; a database in which the floor map, the asset information, and the position information indicating the position of the asset are registered in association with each other; and an asset management map generator that, based on the database, generates an asset management map in which the position of the asset on the floor map is indicated, and in which the position of the asset indicated and the asset information are associated with each other.

Through this, the management system can manage various types of information related to assets in association with each other on the floor map, which makes it possible to centrally manage the assets installed in the building with ease. As such, according to the management system, the user can easily confirm the installation position (also called an “installation location”) of the assets and the information related to the assets on the floor map.

For example, in the management system according to one aspect of the present disclosure, the asset information obtainer may further obtain, as the asset information, information indicating whether the asset is an asset having high managerial importance.

Through this, the management system can manage assets of high managerial importance. As such, according to the management system, the user can easily ascertain which of the assets installed in the building are assets of high managerial importance.

For example, the management system according to one aspect of the present disclosure may further include a management information generator that generates management information related to management of the asset, and the management information generator may register the management information in the database in association with the asset management map.

Through this, the management system can centrally manage information related to the management of assets with ease. As such, according to the management system, the user can read out and confirm information necessary for managing the assets from the database while confirming the installation locations of the assets on the map, which makes it possible to quickly handle the management of the assets.

For example, the management system according to one aspect of the present disclosure may further include a network connection determiner that determines whether the asset is connected to a network. The management information generator may obtain a determination result from the network connection determiner, generate the management information based on the determination result obtained, and register the generated management information in the database in association with the asset management map.

Through this, the management system can manage the assets connected to a network. As such, according to the management system, the installation location of the assets connected to the network can be identified, for example, when a security incident occurs, which makes it possible for the user to quickly handle the security incident.

For example, the management system according to one aspect of the present disclosure may further include a connection relationship analyzer that analyzes a connection relationship between the asset and an other asset based on the determination result, and the management information generator may obtain an analysis result from the connection relationship analyzer and generate the management information based on the analysis result obtained.

Through this, the management system can manage whether an asset connected to a network has a connection relationship with another asset. As such, according to the management system, the other asset in a connection relationship with the asset can be identified based on the connection relationship with the other asset, for example, when a security incident occurs, which makes it possible for the user to quickly handle the security incident.

For example, the management system according to one aspect of the present disclosure may further include an incident handler that, based on the analysis result, determines a response procedure for an incident that can occur in the asset, and the management information generator may obtain the response procedure determined by the incident handler and generate the management information based on the response procedure obtained.

Through this, the management system can manage response procedures and the like when an incident occurs in an asset. As such, according to the management system, when a security incident occurs, the user can confirm the response procedure and handle the incident, which makes it possible to quickly and appropriately handle security incidents.

For example, in the management system according to one aspect of the present disclosure, the management information generator may obtain, for each area among a plurality of areas included in the asset management map, area information indicating whether the area is an area having high managerial importance, and generate the management information based on the area information obtained.

Through this, the management system can manage an area of high managerial importance. As such, according to the management system, the user can preferentially manage assets starting with areas of high managerial importance.

For example, the management system according to one aspect of the present disclosure may further include an acceptor that accepts an instruction from a user, and when the acceptor accepts a modification instruction to modify at least one of the position information or the asset information of the asset, the management information generator may update the database by modifying at least one of the position information or the asset information of the asset registered in the database in accordance with the modification instruction.

Through this, the management system can update and manage the position information and asset information of the assets registered in the database. As such, according to the management system, when an asset is replaced or the like, the user can take appropriate measures in managing the assets based on the updated information.

For example, in the management system according to one aspect of the present disclosure, when the acceptor accepts a modification instruction to modify the management information, the management information generator may update the database by modifying the management information registered in the database in accordance with the modification instruction.

Through this, the management system can update and manage the management information registered in the database. As such, according to the management system, the user can manage the assets based on the updated management information, which makes it possible to take appropriate measures in managing the assets.

For example, the management system according to one aspect of the present disclosure may further include a presenter that presents information to the user, and when the acceptor accepts a presentation instruction to present the asset management map, the presenter may present the asset management map in accordance with the presentation instruction.

Through this, the management system can present the asset management map to the presenter. As such, according to the management system, the user can easily confirm the installation locations or the like of the assets by confirming the asset management map presented in the presenter, which makes it possible to quickly handle the management of the assets.

For example, in the management system according to one aspect of the present disclosure, when the acceptor accepts a presentation instruction to present at least one of the asset information or the management information of an asset selected on the asset management map, the presenter may present the at least one of the asset information or the management information in accordance with the presentation instruction.

Through this, the management system can present registration information related to the assets specified in the asset management map presented in the presenter (and more specifically, various types of information related to the assets registered in the database). As such, according to the management system, the user can confirm information related to the assets at a desired timing.

For example, in the management system according to one aspect of the present disclosure, when the acceptor accepts a display instruction to display a movement trajectory of a position of the sensor on the asset management map, the presenter may display the movement trajectory on the asset management map in accordance with the display instruction.

Through this, the management system can display the movement trajectory of the position of the position sensor in the asset management map, which makes it possible to assist the user in visually confirming the status of an inspection of the asset, for example.

Additionally, a management method according to one aspect of the present disclosure is a management method for centrally managing a plurality of assets provided in a building. The management method includes: detecting an object in a vicinity of a sensor and obtaining a positional relationship between the sensor and the object; generating a floor map indicating a predetermined floor in the building, based on the positional relationship obtained in the obtaining; calculating a self position of the sensor on the floor map generated in the generating; identifying a marker present in a vicinity of the sensor; obtaining asset information related to an asset to which the marker is attached, based on the marker identified in the identifying; calculating a position of the asset on the floor map, based on a relative position of the marker with respect to the sensor; registering the floor map, the asset information, and position information indicating a position of the asset in a database in association with each other; and generating an asset management map in which the position of the asset on the floor map is indicated, and in which the position of the asset indicated and the asset information are associated with each other, based on the database.

Through this, the management method makes it possible to manage various types of information related to assets in association with each other on the floor map, which makes it possible to centrally manage the assets installed in the building with ease. As such, according to the management method, the user can easily confirm the installation location of the assets and the information related to the assets on the floor map.

Additionally, a recording medium according to one aspect of the present disclosure is a non-transitory computer-readable recording medium having recorded thereon a program for causing a computer to execute the management method described above.

Accordingly, the same effects as those of the above-described management method can be achieved using a computer.

Note that these comprehensive or specific aspects may be realized by a system, a method, a device, an integrated circuit, a computer program, or a computer-readable recording medium such as a Compact Disc Read Only Memory (CD-ROM), or may be implemented by any desired combination of systems, methods, devices, integrated circuits, computer programs, and recording media.

Embodiments will be described in detail hereinafter with reference to the drawings. The numerical values, shapes, materials, constituent elements, arrangements and connection states of constituent elements, steps, orders of steps, and the like in the following embodiments are merely examples, and are not intended to limit the scope of the claims. Additionally, of the constituent elements in the following embodiments, constituent elements not denoted in the independent claims, which express the broadest interpretation, will be described as optional constituent elements.

Additionally, the drawings are not necessarily exact illustrations. Configurations that are substantially the same are given the same reference signs in the drawings, and redundant descriptions may be omitted or simplified.

Additionally, in the present disclosure, terms indicating relationships between elements, such as “parallel” and “perpendicular”, terms indicating the shapes of elements, such as “rectangular”, and numerical values do not express the items in question in the strictest sense, but rather include substantially equivalent ranges, e.g., differences of several percent, as well.

### Embodiment 1

Embodiment 1 will be described hereinafter with reference to the drawings.

### Management System

### 1. Overview

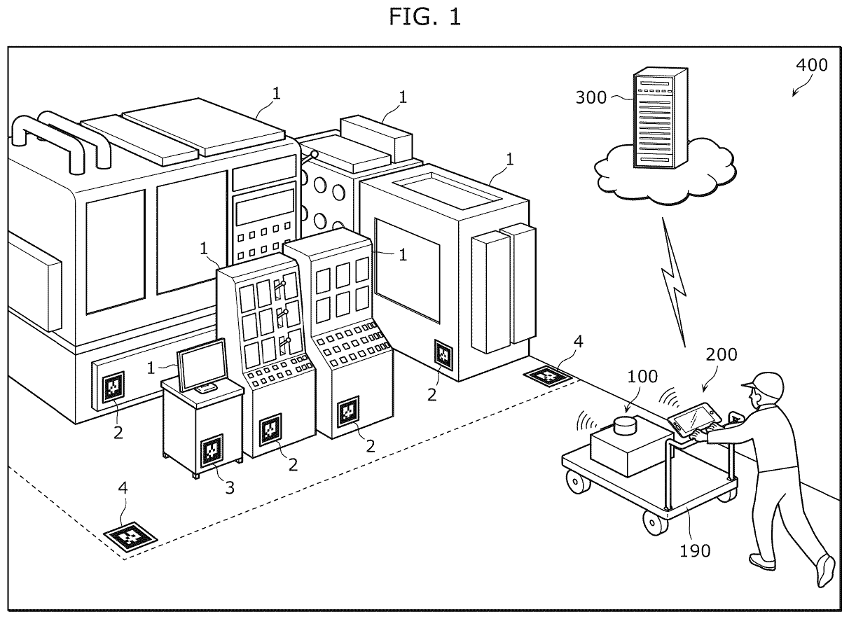

An overview of a management system according to Embodiment 1 will be described here. FIG. 1 is a diagram illustrating an overview of the management system according to an embodiment.

Management system 400 is a system that centrally manages a plurality of assets 1 in a building by, for example, storing asset information related to assets 1 installed in the building and position information indicating the installation positions of assets 1 in the building in a database associated with a map of a floor on which assets 1 are installed (i.e., a floor map).

Here, the building is a factory, an office building, a commercial facility, a medical facility, an educational facility, a public facility, or the like. Asset 1 is a device and apparatus including what is known as a Central Processing Unit (CPU), such as a microcomputer. More specifically, asset 1 is a device and apparatus that may be vulnerable to a security threat, such as a malware infection or a cyberattack, over a network such as the Internet or an intranet, for example. For example, asset 1 includes industrial machinery such as machine tools or robots and control devices for controlling such industrial machinery, facility equipment such as sensors, elevators, entry gates, or air conditioning devices and control devices for controlling such equipment, information processing devices such as personal computers, and the like.

The asset information includes information related to asset 1 itself, and information related to assets such as programs or data held by asset 1. For example, the information related to asset 1 itself is identification information identifying asset 1, a model number, a serial number, a product name, a photograph of the appearance, a size, a material, a manufacturer name, product URL information, an administrator, or the like. The information related to assets such as programs or data held by asset 1 is a program name, a data name, a data type, or the like.

While generating a map of the floor (called a “floor map”), management system 400 stores the position information and asset information of assets 1 installed on the floor in association with the map. More specifically, while generating a map of the floor, asset management map generation device 100 of management system 400 identifies marker 2 on asset 1 and obtains the asset information based on the identified marker 2. Then, asset management map generation device 100 calculates the position of marker 2 with respect to the device, generates an asset management map by associating position information indicating the calculated position and asset information with the floor map, and stores the generated asset management map in a database.

Additionally, when management system 400 identifies marker 3 indicating, for example, that asset 1 having high managerial importance is an important asset, asset 1 to which marker 3 is attached is managed as an important asset. An important asset is an asset of high managerial importance, and may be, for example, asset 1 for which the state is to be confirmed preferentially. Specifically, for example, the important asset may be an asset for which taking stock or manufacturing progress is to be prioritized. Additionally, for example, the important asset may be asset 1 for which operation of the asset is stopped preferentially. Specifically, for example, the important asset is asset 1 that may cause relatively large damage to other assets 1 that are connected to asset 1 (e.g., over a network) in the event of a problem such as a virus infection.

Additionally, when management system 400 identifies marker 4 indicating, for example, that an area is of high managerial importance, the area to which marker 4 is attached (the area surrounded by a broken line in the drawings) is managed as an important area. An important area may be set regardless of the presence or absence of an important asset in that area. The important area is an area of high managerial importance, and may be, for example, an area where the state of asset 1 installed in the area is confirmed often, or may be an area where the state of the area and the state of asset 1 installed in the area are confirmed preferentially when a problem arises.

Management system 400 may generate an asset management map by associating the position of asset 1 on the floor map and the asset information while generating the floor map. Additionally, management system 400 may register the floor map, position information indicating the position of asset 1, and the asset information in a database in association with each other, and then generate the asset management map based on the database. Additionally, management system 400 may update the asset management map based on a database in which asset information or the like has been modified and updated. By having management system 400 present the asset management map to a user, the user can visually confirm the installation position of asset 1. Additionally, by having management system 400 present the asset information and the like of asset 1 selected on the asset management map, the user can easily obtain information about asset 1.

FIG. 1 illustrates an example in which asset management map generation device 100 generates the asset management map by having a user place asset management map generation device 100 on dolly 190 and move across the floor by pushing dolly 190. However, the configuration is not limited to this example. For example, asset management map generation device 100 may have wheels for travel, or may have wheels and a motor that drives the wheels. Additionally, asset management map generation device 100 may be a robot capable of traveling by being operated through a remote controller or the like, for example.

Note that the floor map may be generated by, for example, asset management map generation device 100 equipped with a position sensor such as LiDAR and odometry installed in asset management map generation device 100, or may be generated by information terminal 200 equipped with LiDAR.

### 2. Configuration

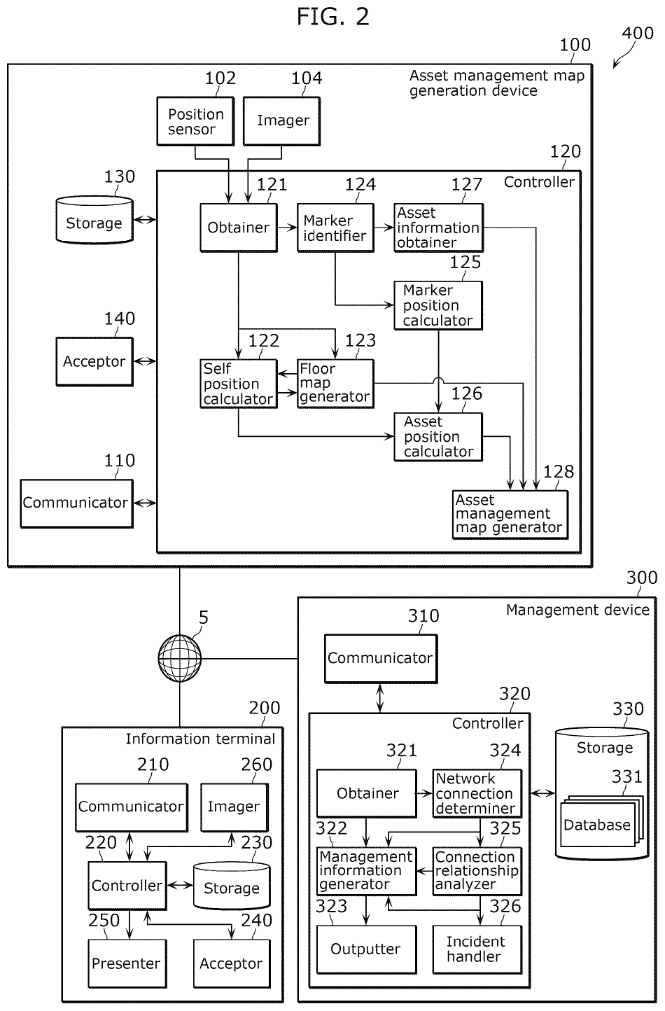

The configuration of management system 400 according to Embodiment 1 will be described next. FIG. 2 is a block diagram illustrating an example of the functional configuration of management system 400 according to Embodiment 1.

Management system 400 includes, for example, asset management map generation device 100, information terminal 200, and management device 300. Asset management map generation device 100, information terminal 200, and management device 300 are communicatively connected over a network. Each constituent element will be described hereinafter.

### 2-1. Asset Management Map Generation Device

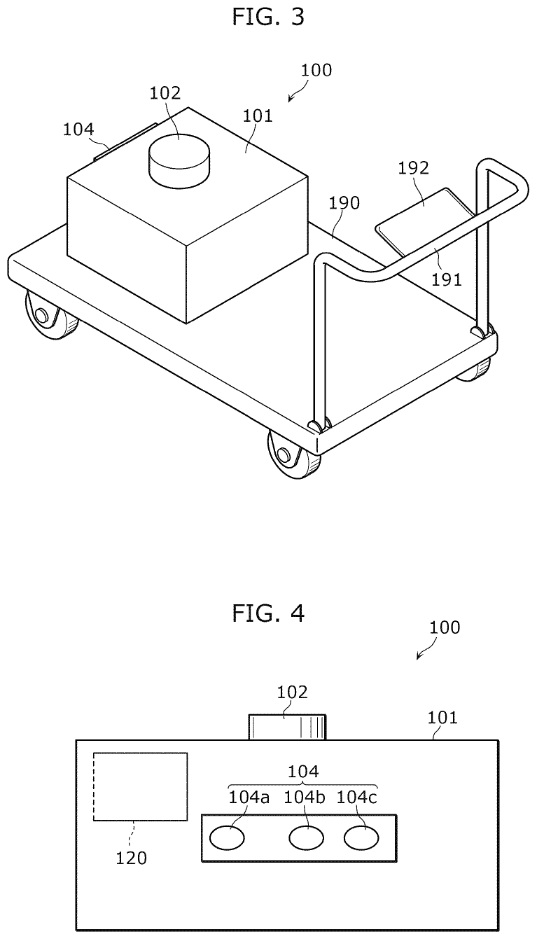

Asset management map generation device 100 will be described first. FIG. 3 is a perspective view illustrating asset management map generation device 100 according to Embodiment 1 at an angle from above. FIG. 4 is a front view illustrating asset management map generation device 100 according to Embodiment 1 from the front.

Asset management map generation device 100 is a device that generates a floor map of a predetermined floor in a building in which asset 1 is installed, and generates an asset management map by associating position information indicating the position of asset 1 in the generated floor map with asset information of asset 1. More specifically, asset management map generation device 100 calculates the position of asset 1 in the floor map based on the floor map, a self position of the device itself, and the relative position of marker 2 while being operated by a user to travel across the predetermined floor, and generates an asset management map in which the calculated position of asset 1 and the asset information are registered in association with each other.

For example, as illustrated in FIG. 3, asset management map generation device 100 may be mounted on dolly 190, and travel over the predetermined floor by being operated by the user. In this example, asset management map generation device 100 is caused to travel by the user pushing dolly 190. Stand 192 on which information terminal 200 is mounted on handle 191 may be attached to dolly 190, for example, or a presenter (not shown) of asset management map generation device 100 may be installed. The presenter may be what is known as a display panel.

Note that asset management map generation device 100 is not limited to the example illustrated in FIG. 3, and may include, for example, a travel mechanism including wheels, a motor for rotating the wheels, and the like in main body 101 of asset management map generation device 100, traveling over the floor by being operated using a remote controller or the like. Additionally, for example, asset management map generation device 100 may further have a handle provided in main body 101, and in this case, asset management map generation device 100 may be caused to travel by the user manipulating the handle.

The configuration of asset management map generation device 100 will be described next. As illustrated in FIG. 2, asset management map generation device 100 includes, for example, position sensor 102, imager 104, communicator 110, controller 120, storage 130, and acceptor 140. Each constituent element will be described hereinafter.

### Position Sensor

Position sensor 102 detects an object in the periphery of itself, and obtains a positional relationship between the object and itself. For example, position sensor 102 is disposed in the center of the top surface of main body 101, and obtains a positional relationship, including a distance and a direction, between asset management map generation device 100 and an object, including a wall or the like, present in the periphery of asset management map generation device 100. Position sensor 102 may be, for example, Light Detection and Ranging (LiDAR) or a lasing rangefinder that detects the positional relationship based on light emitted and then reflected back by an obstruction. Position sensor 102 may perform two-dimensional measurement or three-dimensional measurement of a predetermined region in the periphery of asset management map generation device 100 using one or two optical scanning axes.

Note that asset management map generation device 100 may include other types of sensors in addition to position sensor 102. For example, asset management map generation device 100 may further include a floor surface sensor, an encoder, an accelerometer, an angular velocity sensor, a contact sensor, an ultrasonic sensor, a range sensor, or the like.

### Imager

Imager 104 is an image capturing device that captures an image of the periphery of asset management map generation device 100. For example, imager 104 captures an image that includes a marker in the periphery of asset management map generation device 100. The image may be a single image or a moving image. Imager 104 may be disposed on the front surface of main body 101, or may be disposed rotatably on the top surface. Additionally, imager 104 may be constituted by a plurality of cameras. Imager 104 may be, for example, a stereo camera or an RGB-D camera. An RGB-D camera obtains range image data (“depth”) in addition to color image data (“RGB”). For example, as illustrated in FIG. 4, when imager 104 is an RGB-D camera, imager 104 may include RGB camera 104a, infrared sensor 104b, and projector 104c.

### Communicator

Communicator 110 is communication circuitry for asset management map generation device 100 to communicate with information terminal 200 and management device 300 over network 5. For example, communicator 110 may transmit the asset management map to information terminal 200 and management device 300. Communicator 110 may include communication circuitry for communicating over a wide-area communication network and communication circuitry for communicating over a local communication network. Communicator 110 is, for example, wireless communication circuitry that performs wireless communication. The communication standard of the communication by communicator 110 is not particularly limited.

### Controller

Controller 120 performs various types of information processing for controlling the operations of asset management map generation device 100. Specifically, controller 120 is implemented by a processor, a microcomputer, or dedicated circuitry. Additionally, controller 120 may be implemented by a combination of at least two of a processor, a microcomputer, or dedicated circuitry. For example, controller 120 includes obtainer 121, self position calculator 122, floor map generator 123, marker identifier 124, marker position calculator 125, asset position calculator 126, asset information obtainer 127, and asset management map generator 128.

Obtainer 121 obtains, for example, the positional relationship of the object in the periphery with respect to main body 101 of asset management map generation device 100, obtained by position sensor 102. Obtainer 121 also obtains the image data (i.e., the image information) captured by imager 104. Furthermore, when asset management map generation device 100 includes other types of sensors in addition to position sensor 102, obtainer 121 may further obtain sensor information obtained by the other types of sensors.

Self position calculator 122 calculates a self position, which is the position of asset management map generation device 100 on the floor map, using the positional relationship obtained by position sensor 102 and the floor map generated by floor map generator 123. For example, self position calculator 122 calculates the self position using Simultaneous Localization and Mapping (SLAM) technology. Note that when asset management map generation device 100 uses SLAM technology, self position calculator 122 and floor map generator 123 generate the floor map while calculating the self position, and then sequentially update the self position and the floor map.

Floor map generator 123 generates a floor map representing the predetermined floor. More specifically, floor map generator 123 generates the floor map based on information obtained by position sensor 102 measuring the position and distance of the object in the periphery (i.e., the positional relationship). Floor map generator 123 may generate the floor map related to the surrounding environment of asset management map generation device 100 (objects such as walls, furniture, and the like) using SLAM technology, for example, based on the positional relationship obtained by position sensor 102. Specifically, the floor map is generated through SLAM using LiDAR as described in International Publication WO 2020/026294 (PTL 4). SLAM uses a technique called scan matching to match current observation data (scan data) from LiDAR with reference observation data (scan data) to estimate a most likely current position. Here, after estimating the current position of main body 101 of asset management map generation device 100 equipped with position sensor 102, the floor map is generated using the observation data (i.e., the observation data indicating the most likely current position). The floor map generated through SLAM is an image file in Portable Network Graphics (PNG) format, for example.

Note that floor map generator 123 may generate the floor map using information from other sensors, such as a wheel odometer, a gyro sensor, or the like, in addition to the sensing information from position sensor 102 (e.g., LIDAR). Note that floor map generator 123 may obtain the floor map from information terminal 200 or management device 300, for example, or may read out a floor map stored in storage 130.

Marker identifier 124 identifies a marker in the periphery of main body 101 of asset management map generation device 100. For example, marker identifier 124 detects a marker included in sensing data obtained by position sensor 102 or imager 104 (e.g., sensing data for measuring positional relationships, data such as images, or the like). For example, marker identifier 124 may detect the marker by analyzing an image captured by imager 104 and identifying features of the marker, such as the outline, pattern, color, or the like of the marker. Additionally, for example, marker identifier 124 may identify the marker based on marker information corresponding to a feature of the identified marker, or the marker and the type of the marker, by referring to marker information stored in storage 130. For example, as illustrated in FIG. 1, the marker may be an AR marker, or a plurality of types of markers may be provided. For example, marker 2 is an asset marker attached to asset 1, marker 3 is an important asset marker attached to asset 1 having high managerial importance, and marker 4 is an important area marker indicating an area having high managerial importance.

Marker position calculator 125 calculates the relative position of the marker with respect to main body 101 of asset management map generation device 100. For example, marker position calculator 125 performs projection conversion based on the vertices of the outline of the marker identified by marker identifier 124, and calculates spatial information. For example, based on the position of the marker and outline distortion of the marker in the image, determined according to the angle, distance, and the like from imager 104 (also called a “camera”), the marker is projected and converted into a predetermined rectangle. Then, a conversion matrix (view matrix) for conversion to a camera coordinate system, and an angle of view, are calculated from a marker coordinate system, which takes the marker as the origin and a plane where the marker is located as a horizontal plane (XY plane). The origin of the marker coordinate system is assumed to be determined as, for example, a predetermined vertex, center of gravity, or the like of the rectangular marker. Such a conversion matrix can be calculated using existing methods and libraries. For the angle of view, for example, information on the lens provided in imager 104 used may be stored in advance such that information on the angle of view can be obtained based on the stated information. Additionally, instead of calculating a conversion matrix for conversion from the marker coordinate system to the camera coordinate system, a conversion matrix for conversion to the marker coordinate system based on the camera coordinate system may be calculated.

Additionally, for example, when marker 4 (e.g., a marker indicating an important area) is identified by marker identifier 124, marker position calculator 125 calculates the relative position of marker 4 with respect to main body 101 of asset management map generation device 100. Marker position calculator 125 converts the calculated relative position of marker 4 into its own coordinate system using the self position of main body 101 of asset management map generation device 100 on the floor map, and calculates the position of marker 4 on the floor map. For example, if the position and orientation of main body 101 of asset management map generation device 100 at time t, generated by floor map generator 123, are represented by (xmt, ymt, θmt), the position of marker 4 before the conversion is represented by (xbt, ybt, θbt), and the position of marker 4 after the conversion is represented by (xit, yit, θit), then (xit, yit, θit)=(xmt, ymt, θmt)+(xbt, ybt, θbt).

Asset position calculator 126 calculates the position on the floor map of asset 1 to which the identified marker is attached, based on the positional relationship with the object in the periphery of itself, the self position on the floor map, and a relative position between the self and the marker. Note that although “self” refers to position sensor 102 and imager 104, “self” may refer to the device that includes these sensors (here, main body 101 of asset management map generation device 100). Asset position calculator 126 registers position information indicating the calculated position of asset 1 on the floor map in a database (not shown) in association with the identification information of asset 1. The position information is, specifically, coordinate information in the floor map.

Asset information obtainer 127 obtains the asset information related to asset 1 to which the marker is attached, based on the marker identified by marker identifier 124. Asset information obtainer 127 further obtains, as the asset information, information indicating whether asset 1 is an asset having high managerial importance (referred to as an “important asset”) (also called “important asset information” hereinafter). For example, if the marker is an AR marker, asset information obtainer 127 obtains the important asset information as the asset information in addition to the asset information of asset 1 by reading information provided by marker 3 (referred to as an “important asset marker”) identified by marker identifier 124. In other words, marker 3 includes asset information including information indicating whether asset 1 to which the marker is attached is an important asset. Asset information obtainer 127 registers the asset information including the important asset information in a database (not shown) in association with the position information of asset 1.

Asset management map generator 128 generates an asset management map based on a database (not shown), and more specifically, based on the floor map, the position information indicating the position of asset 1 on the floor map, and the asset information of asset 1. In the asset management map, the position of asset 1 is indicated on the floor map, and the position of asset 1 indicated is associated with the asset information. Additionally, asset management map generator 128 may modify the asset management map based on an instruction from the user accepted by acceptor 140.

### Storage

Storage 130 is a storage device that stores control programs and the like for controlling the operations of controller 120. For example, storage 130 may store the floor map generated by floor map generator 123, the positional relationship obtained by position sensor 102, the relative position of the marker calculated by marker position calculator 125, the database in which the floor map, the position information indicating the position of asset 1, and the asset information are registered in association with each other, the asset management map generated by asset management map generator 128, and the like. Storage 130 is realized by a Hard Disk Drive (HDD), Flash memory, or the like, for example.

### Acceptor

Acceptor 140 is a user interface that accepts user instructions. Here, the user is a user of asset management map generation device 100, and is a person or robot. Acceptor 140 may be realized by, for example, a touch panel, a display panel, hardware buttons, a camera, a microphone, or the like. The display panel has a function for displaying images and a function for accepting manual inputs from the user, and accepts input operations to a numerical keypad image or the like displayed in the display panel, which is a liquid crystal panel or an organic electroluminescence (EL) panel. The microphone accepts voice input from the user.

Although an example in which acceptor 140 is a constituent element of asset management map generation device 100 is described here, acceptor 140 may be integrated with at least one of the other constituent elements of management system 400. For example, acceptor 140 may be incorporated into information terminal 200, may be incorporated into a remote controller (not shown), or may be incorporated into management device 300.

### 2-2. Information Terminal

Information terminal 200 will be described next. Information terminal 200, for example, a mobile information terminal such as a smartphone, a tablet terminal, or the like used by a user, but may be a stationary information terminal such as a personal computer or the like. Information terminal 200 may be a dedicated terminal for management system 400. Information terminal 200 includes communicator 210, controller 220, storage 230, acceptor 240, presenter 250, and imager 260. Each constituent element will be described hereinafter.

### Communicator

Communicator 210 is communication circuitry for information terminal 200 to communicate with asset management map generation device 100 and management device 300 over network 5. Communicator 210 may include communication circuitry for communicating over a wide-area communication network and communication circuitry for communicating over a local communication network. Communicator 210 is, for example, wireless communication circuitry that performs wireless communication. The communication standard of the communication by communicator 210 is not particularly limited.

### Controller

Controller 220 controls the display of images in acceptor 240, and performs identification processing and the like for instructions input by the user (for example, voice recognition processing, when voice is input). Controller 220 may be implemented by a microcomputer, for example, or may be implemented by a processor.

### Storage

Storage 230 is a storage device that stores a dedicated application program and the like for controller 220 to execute. Storage 230 is implemented by semiconductor memory or the like, for example.

### Acceptor

Acceptor 240 accepts instructions from the user. More specifically, acceptor 240 accepts input operations for transmitting instructions from the user to asset management map generation device 100 and management device 300. Acceptor 240 may be realized by, for example, a touch panel, a display panel, hardware buttons, a microphone, or the like. The touch panel may be, for example, a capacitive touch panel or a resistive touch panel. The display panel has a function for displaying images and a function for accepting manual inputs from the user, and accepts input operations to a numerical keypad image or the like displayed in the display panel, which is a liquid crystal panel or an organic electroluminescence (EL) panel. The microphone accepts voice input from the user.

For example, acceptor 240 accepts an instruction to start generating an asset management map, an instruction to modify or add information related to asset 1 and the area associated with the asset management map, an instruction to start inspecting asset 1, and the like, which are input by the user, and transmits the accepted instructions to asset management map generation device 100 and management device 300. The information related to asset 1 is, for example, the position information indicating the position of asset 1 on the floor map, the asset information, the inspection information, and the like. The asset information includes detailed information such as the specifications of asset 1, information related to the user of asset 1, and information indicating whether asset 1 is an important asset. The information related to the area is, for example, position information indicating the position of the area on the floor map, size information indicating the size of the area, information indicating whether the area is an important area, the inspection information, and the like. When information related to asset 1 and information related to the area, input by the user, are accepted, acceptor 240 transmits the accepted information to asset management map generation device 100 and management device 300, and stores the information in storage 230.

### Presenter

Presenter 250 presents information to the user. Specifically, for example, when acceptor 240 accepts a presentation instruction to present the asset management map, presenter 250 presents the asset management map in accordance with the presentation instruction. For example, when acceptor 240 accepts a presentation instruction to present at least one of the asset information or the management information of an asset selected on the asset management map, presenter 250 presents the at least one of the asset information or the management information in accordance with the presentation instruction. Additionally, for example, when acceptor 240 accepts a display instruction to display a movement trajectory of the position of position sensor 102 on the asset management map, presenter 250 displays the movement trajectory on the asset management map in accordance with the display instruction.

Additionally, presenter 250 may present asset information, map information, position information, management information, or the like registered in association with a database, for example, in accordance with an instruction accepted by acceptor 240, or may present a result of searching for a predetermined asset 1 in accordance with a search instruction.

Presenter 250 may also present asset information associated with a marker captured by imager 260, for example.

Note that presenter 250 may include a display device that displays the above-described information as an image based on control by controller 220, and an audio output device that outputs audio information as audio. The display device is, for example, a liquid crystal (LC) panel or an organic electroluminescence (EL) panel. The audio output device is, for example, a speaker.

### Imager

Imager 260 is a camera and is implemented by an image sensor or the like. Imager 260 may capture an image of the appearance of asset 1, or may capture marker 2 attached to asset 1. For example, when imager 260 captures marker 2, asset information of asset 1 is presented by presenter 250.

### 2-3. Management Device

Management device 300 is a management device that, for example, obtains the asset management map, the floor map, the position information of asset 1, the asset information of asset 1, and the like, registers the obtained information in association with database 331, and centrally manages the plurality of assets 1. Additionally, management device 300 may generate management information related to the management of asset 1, and register the management information in database 331 in association with the asset management map. Management device 300 may be an edge server installed in a building, for example, or may be a cloud server.

Management device 300 includes, for example, communicator 310, controller 320, and storage 330.

### Communicator

Communicator 310 is communication circuitry for management device 300 to communicate with asset management map generation device 100 and information terminal 200 over network 5. For example, communicator 310 may transmit information registered in database 331 to asset management map generation device 100 and information terminal 200. Communicator 310 may include communication circuitry for communicating over a wide-area communication network and communication circuitry for communicating over a local communication network. Communicator 310 is, for example, wireless communication circuitry that performs wireless communication. The communication standard of the communication by communicator 110 is not particularly limited.

### Controller

Controller 320 performs various types of information processing related to the management of asset 1 based on the information transmitted from asset management map generation device 100 and user instructions output from information terminal 200. Controller 320 may be implemented by a microcomputer, for example, or may be implemented by a processor.

Obtainer 321 obtains, for example, the asset management map, the floor map, the position information related to the position of asset 1 on the floor map, the asset information of asset 1, the movement trajectory of position sensor 102, and the like from asset management map generation device 100. Obtainer 321 also obtains the user instructions accepted by acceptor 240 from information terminal 200.

Management information generator 322 generates management information related to the management of asset 1, for example, and registers the generated management information in database 331 in association with the asset management map. The management information is information related to the management of asset 1, and more specifically, is information necessary to manage cybersecurity risks for asset 1 and a plurality of assets 1 connected to asset 1.

For example, management information generator 322 may obtain a determination result from network connection determiner 324 (described later) and generate the management information based on the obtained determination result. Upon obtaining a determination result as to whether asset 1 is connected to a network from network connection determiner 324, management information generator 322 registers the management information in database 331 based on an address of asset 1 included in the determination result. At this time, along with the address of asset 1, information indicating whether asset 1 is connected to a network (also called “information indicating whether there is a network connection”) may be registered in database 331 as the management information. Additionally, if the address of asset 1 is already registered in database 331, management information generator 322 may verify the address of asset 1 included in the determination result against the address of asset 1 in database 331 to confirm whether the addresses match. For example, if the addresses do not match, management information generator 322 updates the address of asset 1 in database 331 to the address of asset 1 included in the determination result.

Additionally, for example, management information generator 322 may obtain an analysis result from connection relationship analyzer 325 (described later) and generate the management information based on the obtained analysis result. Upon obtaining an analysis result related to the connection relationship between asset 1 and another asset 1 from connection relationship analyzer 325, management information generator 322 may register identification information of the other asset 1 having the connection relationship with asset 1, identification information of the network being used, whether or not there is another network, aside from the stated network, which can be connected to, a name and identification information of the system to which assets 1 and the other asset 1 belong, and the like in database 331 as the management information.

Additionally, for example, management information generator 322 obtains a response procedure for responding to an incident determined by incident handler 326 (described later) and generates the management information based on the obtained response procedure. Upon obtaining a response procedure for responding to an incident that can occur in asset 1 from incident handler 326, management information generator 322 may register the incident that can occur in asset 1 and the response procedure in database 331 as the management information.

Additionally, for example, management information generator 322 may, for each of a plurality of areas in the asset management map, obtain area information indicating whether that area is an area having high managerial importance (also called an “important area”; this area information will be called “important area information” hereinafter), based on a user instruction or marker 4 (the important area marker), and may then generate the management information based on the obtained area information. For example, upon obtaining a setting instruction to set a predetermined area included in the asset management map as an important area, management information generator 322 registers “1” in database 331 as information indicating that the area is an important area, in association with the coordinate information of the area, for example. Additionally, for example, when information indicating that marker 4 (the “important area marker”) has been identified by marker identifier 124 and position information indicating the position of marker 4 calculated by marker position calculator 125 is obtained, management information generator 322 extracts the asset management map and the area including the position of marker 4 from database 331. Specifically, management information generator 322 refers to the map information registered in database 331 and specifies an area (and more specifically, the coordinate information of an area) including the calculated position of marker 4. Management information generator 322 then specifies an asset management map including the specified area, and extracts that information. Management information generator 322 registers “1” in database 331 as the area information indicating that the area included in the specified asset management map is an important area, in association with the coordinate information of that area, for example.

Outputter 323 outputs the management information generated by management information generator 322 and various types of information registered in database 331 to asset management map generation device 100 and information terminal 200.

Network connection determiner 324 determines whether asset 1 is connected to a network. For example, of the plurality of assets 1 installed on the predetermined floor, network connection determiner 324 may detect asset 1 connected to the network and output information identifying the detected asset 1 as a determination result. For example, network connection determiner 324 may utilize a general network protocol, such as Ping (Internet Control Message Protocol (ICMP) Echo), to obtain the addresses of assets 1 connected to the network and output a list of the obtained addresses to management information generator 322 as the determination result.

Connection relationship analyzer 325 analyzes the connection relationship between asset 1 and the other asset 1 based on the determination result from network connection determiner 324. For example, for the plurality of assets 1 installed in the building, connection relationship analyzer 325 may obtain information such as whether the assets are components of a single system, whether the assets are connected over an intranet, whether the assets can access a predetermined network access point, and the like, and analyze the connection relationship between asset 1 and the other asset 1 based on the obtained information. The information may be obtained based on segment information of the network stored in storage 330, configuration information of the system, and the like.

Incident handler 326 determines a response procedure for responding to an incident that can occur in asset 1 based on the analysis result from connection relationship analyzer 325. For example, incident handler 326 refers to table information in which types of incidents are stored in storage 330 in association with response procedures for each type, estimates an incident that can occur in asset 1 according to an attribute of asset 1 in a connection relationship with another asset 1, and determines a response procedure for the estimated incident. For example, when a plurality of incidents that can occur in asset 1 are estimated, incident handler 326 determines incidents in the order from the highest probability of occurrence, as well as the response procedures for those incidents, and outputs the response procedures for incidents having at least a predetermined probability to management information generator 322.

### Storage

Storage 330 is a storage device that stores database 331, a dedicated application program for controller 320 to execute, and the like. Storage 330 also stores database 331, segment information of the network in the building, configuration information of the system, the table information, and the like, for example. Storage 330 is implemented as a Hard Disk Drive (HDD), for example, but may be implemented as semiconductor memory or the like.

The floor map, the position information indicating the position of asset 1 on the floor map, and the asset information of asset 1 are registered in database 331 in association with each other. Furthermore, the asset management map may also be registered in association in database 331, and the management information related to the management of asset 1 may be registered in association as well. Additionally, inspection information related to the inspection of asset 1 (also called an “inspection history”), and history information such as the movement trajectory of position sensor 102 in the inspection of asset 1, may also be registered in database 331.

### 3. Operations

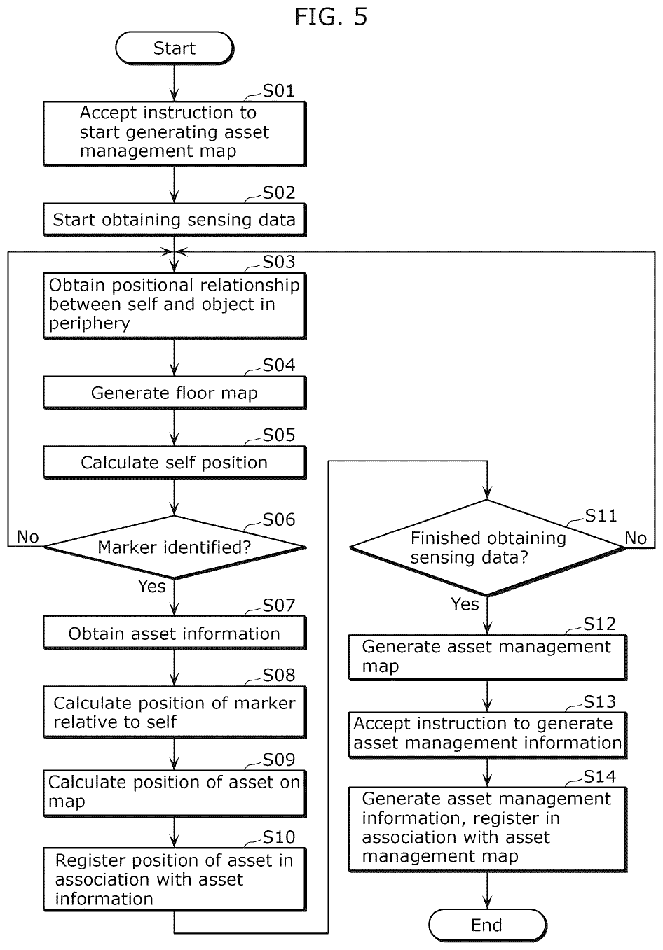

Operations by management system 400 according to Embodiment 1 will be described next with reference to the drawings. FIG. 5 is a flowchart illustrating an example of operations by management system 400 according to Embodiment 1.

First, when acceptor 140 of asset management map generation device 100 accepts an instruction to start generating an asset management map (S01), controller 120 of asset management map generation device 100 causes the plurality of sensors included in asset management map generation device 100, including position sensor 102 and imager 104, to start obtaining sensing data (S02). More specifically, controller 120 of asset management map generation device 100 outputs a sensing data obtainment start command to each of the plurality of sensors, including position sensor 102 and imager 104.

Upon receiving the sensing data obtainment start command, position sensor 102 detects an object in the periphery of itself and obtains a positional relationship between of the object relative to itself (S03). Additionally, upon receiving the sensing data obtainment start command, imager 104 captures an image of the periphery of itself (not shown). The image may be a single image or a moving image. Note that although “self” refers to each of position sensor 102 and imager 104, “self” may refer to main body 101 of asset management map generation device 100 equipped with those sensors. For example, if position sensor 102 and imager 104 are installed in the center of the top part of main body 101, the position of those sensors may be taken as the position of main body 101.

Next, upon obtaining the positional relationship obtained by position sensor 102 (not shown), obtainer 121 of controller 120 and outputs the positional relationship to floor map generator 123 (not shown).

Next, floor map generator 123 generates a floor map indicating a predetermined floor based on the positional relationship of the object in the periphery with respect to the self obtained by position sensor 102 in step S03 (S04).

Next, self position calculator 122 calculates a self position, which is the position of position sensor 102, on the floor map generated by floor map generator 123 in step S04 (S05). Although not illustrated, self position calculator 122 adds a timestamp to the calculated self position of position sensor 102 and stores the self position in storage 130.

Marker identifier 124 determines whether to identify a marker in the image captured by imager 104 (S06), and if a marker is not to be identified in the image (No in S06), the sequence returns to step S03. On the other hand, if marker identifier 124 identifies a marker in the image (Yes in S06), asset information obtainer 127 obtains the asset information related to asset 1 to which the marker is attached, based on the identified marker (S07).

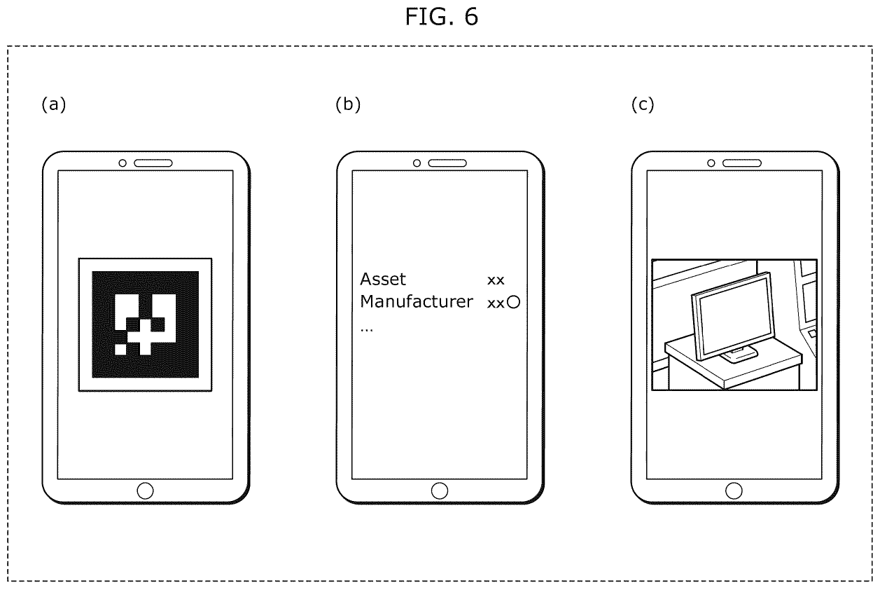

For example, the marker is an AR marker, as illustrated in FIG. 1. The user may start up imager 260 of information terminal 200 to capture an image of marker 2 attached to asset 1, and confirm the asset information provided by marker 2. FIG. 6 is a diagram illustrating an image presented in presenter 250 of information terminal 200. As indicated in (a) of FIG. 6, when imager 260 of information terminal 200 captures an image of marker 2, presenter 250 displays an image of marker 2. Next, as indicated in (b) of FIG. 6, controller 220 of information terminal 200 obtains the asset information provided in the captured marker 2 and causes presenter 250 to present the obtained asset information. At this time, if the asset information includes an image of the appearance of asset 1, presenter 250 presents an image of the appearance of asset 1, as indicated in (c) of FIG. 6. Note that if the asset information does not include an image of the appearance of asset 1, the user may capture an image of the appearance of asset 1 using imager 260 of information terminal 200, and output image information of the captured image to asset management map generation device 100. Controller 120 of asset management map generation device 100 adds the image information of the image of the appearance of asset 1 to the asset information of asset 1 stored in storage 130 by asset information obtainer 127, and stores the image information in storage 130.

Marker position calculator 125 then calculates the relative position of the marker identified by marker identifier 124 relative to the self (here, imager 104) (S08). Although not illustrated, marker position calculator 125 adds a timestamp to the calculated relative position of the marker and stores the timestamp in storage 130 as well.

Next, asset position calculator 126 calculates the position of asset 1 on the floor map (also called a “map”) based on the positional relationship, the self position, and the relative position of the marker (S09).

Next, controller 120 registers the position information indicating the position of asset 1 on the floor map, calculated by asset position calculator 126, in a database (not shown) in storage 130, in association with the asset information of asset 1 obtained by asset information obtainer 127 (S10). In other words, the floor map, the asset information, and the position information are registered in the database in association with each other.

Controller 120 determines whether the obtainment of the sensing data has ended (S11), and if the obtainment of the sensing data is determined not to have ended (No in S11), the sequence returns to step S03. On the other hand, if controller 120 determines that the obtainment of the sensing data has ended (Yes in S11), asset management map generator 128 generates, based on the database, an asset management map in which the position of asset 1 is indicated on the floor map, and in which the position of asset 1 indicated and the asset information are associated with each other (S12). Although not illustrated, asset management map generator 128 registers the generated asset management map in a database in storage 130.

When the asset management map is generated, controller 120 of asset management map generation device 100 transmits a notification (not shown) indicating the asset management map is complete to information terminal 200 through communicator 110. At this time, asset management map generation device 100 may output, to management device 300, the asset management map, the floor map registered in association therewith in the database, the position information indicating the position of asset 1 on the floor map, and the asset information of asset 1. When controller 320 of management device 300 obtains the asset management map and the information thereof from asset management map generation device 100 through communicator 310, those items are stored in database 331 in storage 330 (not shown).

Upon obtaining the notification through communicator 210, controller 220 of information terminal 200 causes presenter 250 to present the notification (not shown).

When acceptor 240 of information terminal 200 accepts a presentation instruction to present the asset management map, controller 220 outputs the presentation instruction to asset management map generation device 100 through communicator 210 (not shown).

Upon obtaining a presentation instruction to present the asset management map through communicator 110, controller 120 of asset management map generation device 100 outputs the asset management map to information terminal 200 through communicator 110 (not shown).

Upon obtaining the asset management map through communicator 210, controller 220 of information terminal 200 causes presenter 250 to present the asset management map (not shown).

Next, when acceptor 240 of information terminal 200 accepts a generation instruction to generate the management information of asset 1 (S13), controller 220 outputs the generation instruction to management device 300 through communicator 210 (not shown).

Upon obtaining the generation instruction to generate the management information of asset 1 through communicator 310, obtainer 321 of management device 300 outputs that instruction to management information generator 322 (not shown).

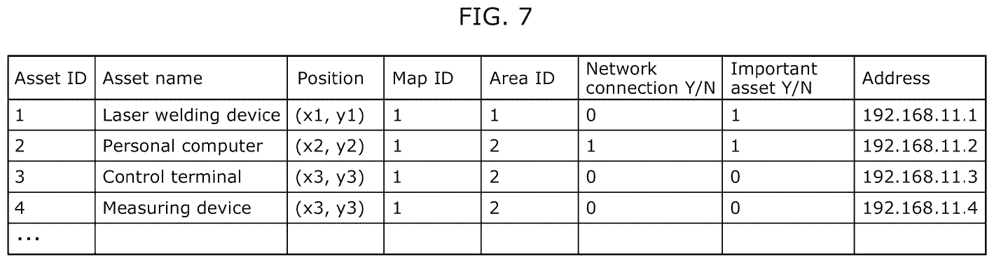

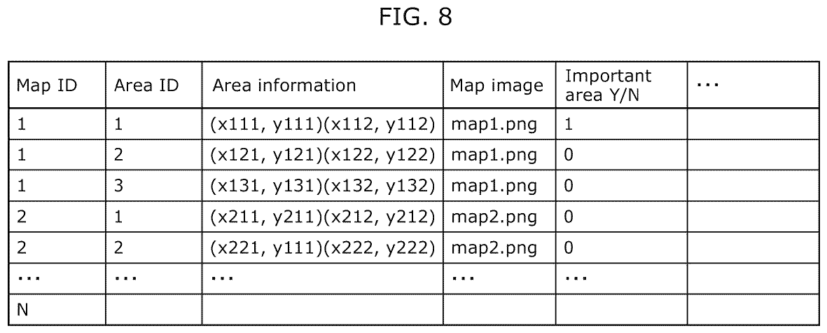

Upon obtaining the instruction, management information generator 322 generates the management information for asset 1, and registers the generated management information in database 331 in association with the asset management map (S14). More specifically, as illustrated in FIGS. 7 and 8, by registering the management information in association with an asset ID (identifier) in database 331, management information generator 322 registers the management information in association with the asset management map. FIG. 7 is a diagram illustrating an example of the database. FIG. 8 is a diagram illustrating an example of the map information.

Information indicating whether asset 1 is an asset having high managerial importance (i.e., an important asset) (that is, important asset information) is registered in database 331. For example, as illustrated in FIG. 7, the important asset information is a flag indicating whether the asset is an important asset. For example, a value of “0” for the flag indicates that the asset is not an important asset, whereas a value of “1” for the flag indicates that the asset is an important asset.

Management information generator 322 registers a flag indicating whether asset 1 is connected to a network and an address of asset 1 in database 331 based on the determination result from network connection determiner 324, for example. For example, a value of “0” for the flag indicates that asset 1 is not connected to the network, whereas a value of “1” for the flag indicates that asset 1 is connected to the network. The address of asset 1 is, for example, an IP address.

Although not illustrated in FIGS. 7 and 8, management information generator 322 may register information indicating the connection relationship between asset 1 and another asset 1 in association with the ID of asset 1, based on the analysis result from connection relationship analyzer 325. The information indicating the connection relationship is, for example, the IDs of asset 1 and the other asset 1 constituting a single system, an ID of the network to which the assets are connected, and the like.

Although not illustrated, management information generator 322 may register an incident that can occur in asset 1, determined by incident handler 326, in association with a response procedure for responding to the incident and the ID of asset 1.

Management information generator 322 registers, for each of the plurality of areas included in the asset management map, information indicating whether the area is an area that is important in terms of management (the “important area”) in association with the area ID. For example, as illustrated in FIG. 8, the information indicating whether the area is an important area may be a flag indicating whether the area is an important area. For example, a value of “0” for the flag indicates that the area is not an important area, whereas a value of “1” for the flag indicates that the area is an important area. Management information generator 322 may register the flag indicating whether an area is an important area in association with area information (i.e., coordinate information on the floor map) calculated based on an input instruction from the user or marker 4 indicating an important area (see FIG. 1).

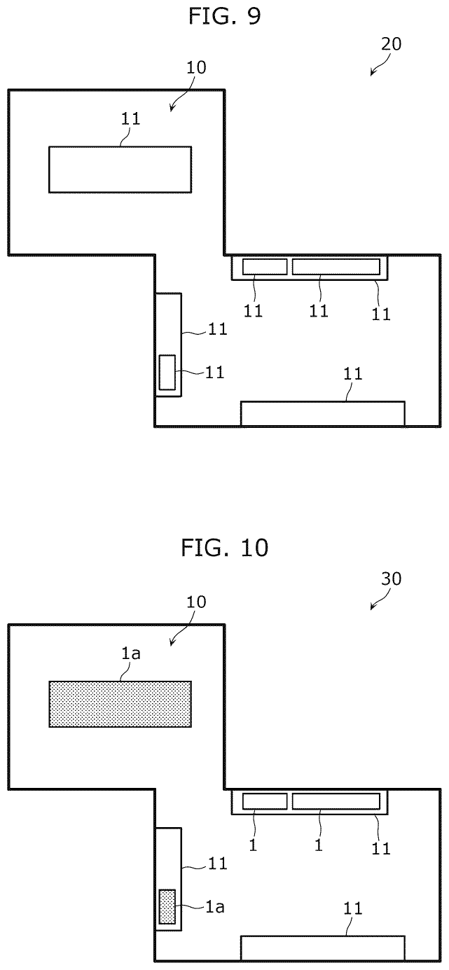

Note that the map image is image information of the floor map illustrated in FIG. 9. FIG. 9 is a diagram illustrating an example of the floor map. As illustrated in FIG. 9, floor map 20 is a map illustrating the positions at which objects 11 are arranged on a predetermined floor 10. When the asset information of asset 1 is registered in association with this floor map, assets 1 and important assets 1a are indicated as illustrated in FIG. 10. FIG. 10 is a diagram illustrating an example of the asset management map. In asset management map 30, the positions of assets 1 and important assets 1a are displayed on the map by indicating the positions of assets 1 on the floor map, and registering the asset information in association with the positions of the indicated assets 1.

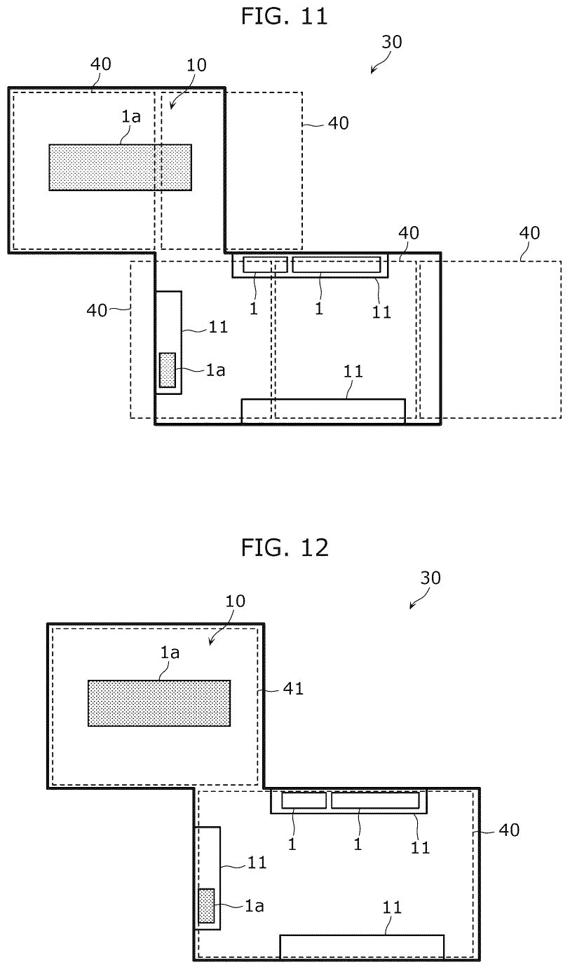

Asset management map 30 is divided into a plurality of rectangular areas 40, as illustrated in FIGS. 11 and 12. FIG. 11 is a diagram illustrating an example of area division in asset management map 30. FIG. 12 is a diagram illustrating another example of area division in asset management map 30. Although management information generator 322 is assumed to perform the area division here, asset management map generator 128 may perform the area division instead. Management information generator 322 may divide the asset management map into a plurality of rectangular areas 40 based on the map image of the floor map. For example, as illustrated by the broken line rectangles in FIG. 11, management information generator 322 may divide the asset management map into areas, each having a constant surface area and a predetermined size (e.g., 10 meters×10 meters or the like), and may divide asset management map 30 into rectangular areas by setting areas surrounding the perimeter of predetermined spaces as illustrated in FIG. 12. At this time, management information generator 322 may set important area 41 based on an instruction from the user or marker 4 (the “important area marker”).

Returning to FIG. 5, although not illustrated in FIG. 5, when acceptor 240 of information terminal 200 accepts an instruction to end the generation of the management information, controller 220 of information terminal 200 outputs the instruction to management device 300 through communicator 210. Upon obtaining the instruction through communicator 310, controller 320 of management device 300 ends the processing for generating the asset management map and management information.

Through this, management system 400 can generate asset management map 30 and register the various types of information related to assets 1 in association with asset management map 30, and can therefore centrally manage the plurality of assets 1 installed in the building.

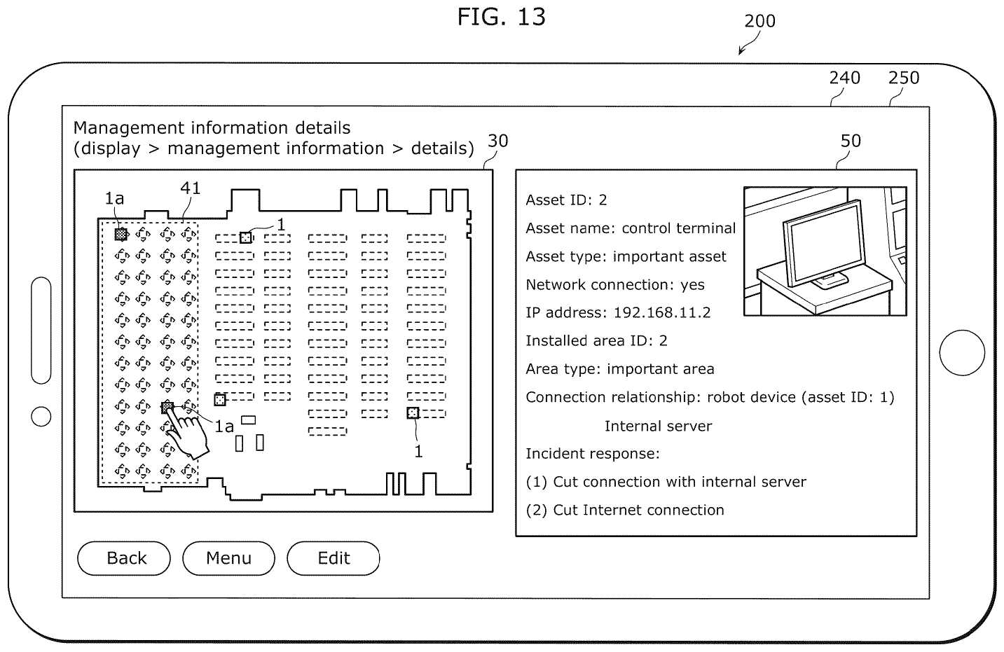

FIG. 13 is a diagram illustrating an example of the display of the asset management map and management information. For example, as illustrated in FIG. 13, the user can cause presenter 250 (e.g., a monitor) of information terminal 200, which is a personal computer, a tablet terminal, or the like, to display asset management map 30, and can then confirm the positions of assets 1 and important assets 1a displayed on asset management map 30. By tapping icons for assets 1 and important assets 1a displayed on asset management map 30, the user can then confirm various types of information registered in database 331 (registered information 50) with respect to assets 1 and important assets 1a registered in database 331.

Additionally, areas 40 and important area 41 may be displayed on asset management map 30. Although not illustrated, presenter 250 may display a list of registered information 50 of assets 1 registered in database 331 in table format, may cause the list of assets 1 installed in an area to be displayed in response to a user tapping and selecting a specific area 40 (or important area 41) displayed on asset management map 30, and may search for asset 1 by having a name (an “asset name”) or the like entered into a search cell.

### 4. Effects, etc.

As described above, management system 400 according to Embodiment 1 is a management system that centrally manages a plurality of assets 1 provided in a building, and includes: position sensor 102 that detects object 11 in a vicinity of position sensor 102 and obtains a positional relationship between position sensor 102 and object 11; floor map generator 123 that, based on the positional relationship obtained by position sensor 102, generates a floor map indicating a predetermined floor in the building; self position calculator 122 that calculates a self position of position sensor 102 on floor map 20 generated by floor map generator 123; marker identifier 124 that identifies marker 2 present in a vicinity of imager 104; asset information obtainer 127 that, based on marker 2 identified by marker identifier 124, obtains asset information related to asset 1 to which marker 2 is attached; asset position calculator 126 that, based on the positional relationship, the self position, and a relative position of the marker with respect to imager 104, calculates a position of asset 1 on floor map 20; a database (not shown in FIG. 2) in which floor map 20, the asset information, and the position information indicating the position of the asset are registered in association with each other; and asset management map generator 128 that, based on the database, generates asset management map 30 in which the position of the asset on floor map 20 is indicated, and in which the position of the asset indicated and the asset information are associated with each other.

Through this, management system 400 can manage various types of information related to assets 1 in association with each other on floor map 20, which makes it possible to centrally manage assets 1 installed in the building with ease. As such, according to management system 400, the user can easily confirm the installation location of assets 1 and the information related to assets 1 on floor map 20.

For example, in management system 400, asset information obtainer 127 may further obtain, as the asset information, information indicating whether asset 1 is an asset having high managerial importance.

Through this, management system 400 can manage assets of high managerial importance. As such, according to management system 400, the user can easily ascertain which of assets 1 installed in the building are assets of high managerial importance.

For example, management system 400 may further include management information generator 322 that generates management information related to the management of asset 1, and management information generator 322 may register the management information in database 331 in association with asset management map 30.

Through this, management system 400 can centrally manage information related to the management of assets 1 with ease. As such, according to management system 400, the user can read out and confirm information necessary for managing assets 1 from database 331 while confirming the installation locations of assets 1 on asset management map 30, which makes it possible to quickly handle the management of assets 1.

For example, management system 400 may further include network connection determiner 324 that determines whether asset 1 is connected to a network, and management information generator 322 may obtain a determination result from network connection determiner 324, generate management information based on the determination result obtained, and register the management information generated in database 331 in association with asset management map 30.

Through this, management system 400 can manage assets 1 connected to a network. As such, according to management system 400, the installation location of assets 1 connected to the network can be identified, for example, when a security incident occurs, which makes it possible for the user to quickly handle the security incident.

For example, management system 400 may further include connection relationship analyzer 325 that analyzes a connection relationship between asset 1 and an other asset 1 based on the determination result, and management information generator 322 may obtain an analysis result from connection relationship analyzer 325 and generate management information based on the analysis result obtained.

Through this, management system 400 can manage whether asset 1 connected to a network has a connection relationship with another asset 1. As such, according to management system 400, the other asset 1 in a connection relationship with asset 1 can be identified based on the connection relationship with the other asset 1, for example, when a security incident occurs, which makes it possible for the user to quickly handle the security incident.

For example, management system 400 may further include incident handler 326 that, based on the analysis result, determines a response procedure for an incident that can occur in asset 1, and management information generator 322 may obtain the response procedure determined by incident handler 326 and generate the management information based on the response procedure obtained.

Through this, management system 400 can manage response procedures and the like when an incident occurs in asset 1. As such, according to management system 400, when a security incident occurs, the user can confirm the response procedure and handle the incident, which makes it possible to quickly and appropriately handle security incidents.

For example, in management system 400, management information generator 322 may obtain, for each area 40 among a plurality of areas 40 included in asset management map 30, area information indicating whether the area 40 is an area having high managerial importance, and generate the management information based on the area information obtained.

Through this, management system 400 can manage areas of high managerial importance (here, “important area 41”). As such, according to management system 400, the user can preferentially manage assets starting with areas of high managerial importance.

For example, management system 400 may further include acceptor 240 that accepts an instruction from a user, and when acceptor 240 accepts a modification instruction to modify at least one of the position information or the asset information of asset 1, management information generator 322 may update database 331 by modifying at least one of the position information or the asset information of asset 1 registered in database 331 in accordance with the modification instruction.

Through this, management system 400 can update and manage the position information and asset information of assets 1 registered in database 331. As such, according to management system 400, when asset 1 is replaced or the like, the user can take appropriate measures in managing assets 1 based on the updated information.

For example, in management system 400, when acceptor 240 accepts the modification instruction to modify the management information, management information generator 322 may update database 331 by modifying the management information registered in database 331 in accordance with the modification instruction.

Through this, management system 400 can update and manage the management information registered in database 331. As such, according to management system 400, the user can manage assets 1 based on the updated management information, which makes it possible to take appropriate measures in managing assets 1.

For example, management system 400 may further include presenter 250 that presents information to a user, and when acceptor 240 accepts a presentation instruction to present asset management map 30, presenter 250 may present asset management map 30 in accordance with the presentation instruction.

Through this, management system 400 can present asset management map 30 to presenter 250. As such, according to management system 400, the user can easily confirm the installation locations or the like of assets 1 by confirming asset management map 30 presented in presenter 250, which makes it possible to quickly handle the management of assets 1.

For example, in management system 400, when acceptor 240 accepts a presentation instruction to present at least one of the asset information or the management information of asset 1 selected on asset management map 30, presenter 250 presents the at least one of the asset information or the management information in accordance with the presentation instruction.

Through this, management system 400 can present registration information related to assets 1 specified in asset management map 30 presented in presenter 250 (and more specifically, various types of information related to assets 1 registered in database 331). As such, according to management system 400, the user can confirm information related to assets 1 at a desired timing.

Additionally, a management method is a management method for centrally managing a plurality of assets 1 provided in a building.

The management method includes: detecting object 11 in a vicinity of position sensor 102 and obtaining a positional relationship between position sensor 102 and object 11; generating floor map 20 indicating a predetermined floor in the building, based on the positional relationship obtained in the obtaining; calculating a self position of position sensor 102 on floor map 20 generated in the generating; identifying marker 2 present in a vicinity of imager 104; obtaining asset information related to asset 1 to which marker 2 is attached, based on marker 2 identified in the identifying; calculating a position of asset 1 on floor map 20, based on a relative position of the marker with respect to imager 104; registering floor map 20, the asset information, and position information indicating a position of the asset in a database in association with each other; and generating asset management map 30 in which the position of asset 1 on floor map 20 is indicated, and in which the position of asset 1 indicated and the asset information are associated with each other, based on the database.

Through this, the management method can manage various types of information related to assets 1 in association with each other on floor map 20, which makes it possible to centrally manage assets 1 installed in the building with ease. As such, according to the management method, the user can easily confirm the installation location of assets 1 and the information related to the assets on the floor map.

### Embodiment 2

A management system according to Embodiment 2 will be described next. Embodiment 2 differs from Embodiment 1 in that in Embodiment 1, asset management map generation device 100 does not include a travel mechanism such as wheels in main body 101, but in Embodiment 2, the asset management map generation device includes a travel mechanism in main body 101. The following descriptions will focus on points different from Embodiment 1, and descriptions of redundant content will be omitted or simplified.

### 1. Configuration

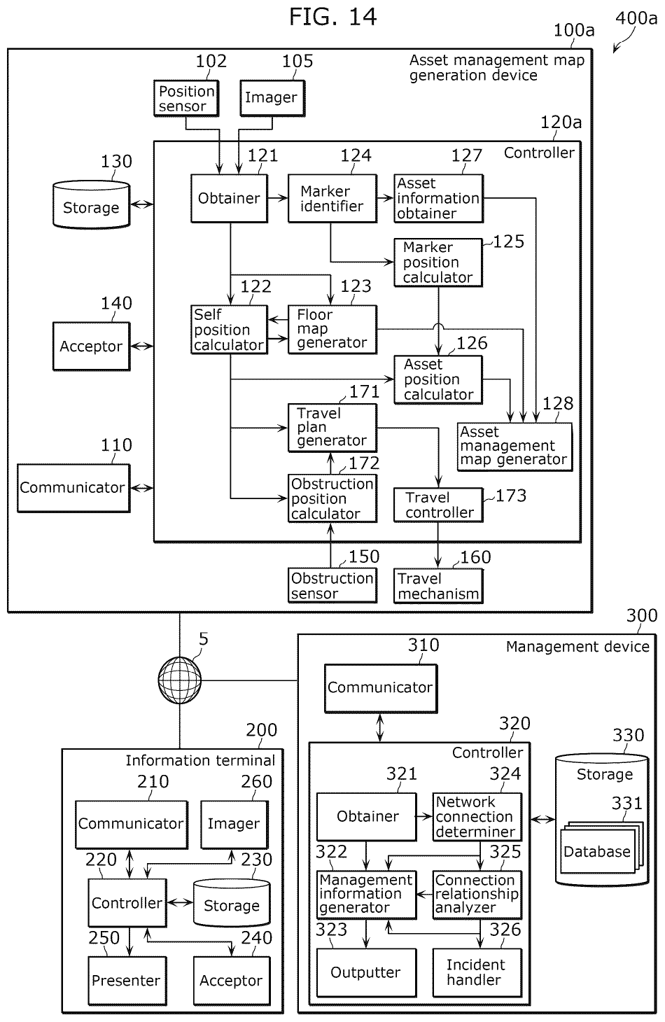

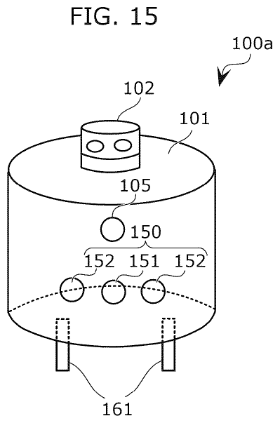

FIG. 14 is a block diagram illustrating an example of the functional configuration of the management system according to Embodiment 2. FIG. 15 is a front view illustrating the asset management map generation device according to Embodiment 2 from the front. In FIG. 14, constituent elements that are the same as those illustrated in FIG. 2 are given the same reference signs.

As illustrated in FIG. 14, management system 400a according to Embodiment 2 includes, for example, asset management map generation device 100a, information terminal 200, and management device 300.

Asset management map generation device 100a differs from asset management map generation device 100 according to Embodiment 1 in that obstruction sensor 150, travel mechanism 160, travel plan generator 171, obstruction position calculator 172, and travel controller 173 are further provided. Note that in Embodiment 2, asset management map generation device 100a includes imager 105, but imager 104 may be included instead as in Embodiment 1. Each constituent element will be described hereinafter.

### Imager

Imager 105 is an image capturing device that captures an image of the periphery of asset management map generation device 100a. For example, imager 105 captures an image that includes a marker in the periphery of asset management map generation device 100a. The image may be a single image or a moving image. Although disposed on the front surface of main body 101, imager 105 may be disposed rotatably on the top surface. Imager 105 is an RGB camera, for example. Additionally, imager 105 may be constituted by a plurality of cameras.

### Controller

Controller 120a includes travel plan generator 171, obstruction position calculator 172, and travel controller 173 in addition to the configuration of controller 120 in Embodiment 1.

Travel plan generator 171 generates a travel plan based on the floor map and the self position. If, when asset management map generation device 100a is traveling in accordance with the travel plan, obstruction sensor 150 detects an obstruction, travel plan generator 171 may change the travel plan based on the position of the obstruction calculated by obstruction position calculator 172.

Obstruction position calculator 172 obtains information related to the obstruction detected by obstruction sensor 150 (e.g., the distance, position, and the like of the obstruction), and calculates the position of the obstruction in the floor map based on the obtained information and the self position calculated by self position calculator 122.

Travel controller 173 controls travel mechanism 160 such that asset management map generation device 100a travels in accordance with the travel plan. More specifically, based on the travel plan, travel controller 173 performs information processing for controlling the operation of travel mechanism 160. For example, based on information such as the floor map, the self position, and the like in addition to the travel plan, travel controller 173 derives control conditions for travel mechanism 160, and based on the control conditions, generates control signals for controlling the operation of travel mechanism 160. Travel controller 173 outputs the generated control signals to travel mechanism 160. Note that details such as the derivation of the control conditions for travel mechanism 160 are similar to those of conventional autonomously traveling robots, and will therefore not be described.

### Obstruction Sensor

Obstruction sensor 150 is a sensor that detects surrounding walls present in front of main body 101 (specifically, in the direction of travel) and obstructions that will interfere with travel, such as furniture or the like. Obstruction sensor 150 uses an ultrasonic sensor, for example. Obstruction sensor 150 includes transmitter 151 disposed in the center of the front surface of main body 101 and receivers 152 disposed on both sides of transmitter 151, and by receiving ultrasonic waves transmitted from transmitter 151 and reflected back by an obstruction, receivers 152 can detect the distance, location, and so on of the obstruction.

Note that asset management map generation device 100a may include sensors other than obstruction sensor 150. For example, floor surface sensors may be disposed in a plurality of locations on the bottom surface of main body 101, to detect whether a floor surface is present as the floor. Additionally, travel mechanism 160 may include an encoder that detects a rotation angle of each of a pair of wheels 161 rotated by a travel motor. Additionally, an accelerometer that detects acceleration when asset management map generation device 100a is traveling, and an angular velocity sensor that detects an angular velocity when asset management map generation device 100a is turning, may be provided as well. A contact sensor that detects displacement of a bumper (not shown) to detect collisions with obstructions may be provided as well.

### Travel Mechanism

Travel mechanism 160 enables asset management map generation device 100a to travel based on instructions from travel controller 173. Travel mechanism 160 includes wheels 161 that travel on the floor, a travel motor (not shown) that applies torque to wheels 161, a housing (not shown) that houses the travel motor, and the like. Asset management map generation device 100a may be a differential two-wheeled type provided with a caster (not shown) as an auxiliary wheel. In this case, by independently controlling the rotation of wheels 161 of each of a pair of travel units, travel mechanism 160 can freely cause asset management map generation device 100a to travel forward, backward, rotate to the left, rotate to the right, and the like.

### 2. Operations

Operations by management system 400a according to Embodiment 2 will be described next. In Embodiment 1, asset management map generation device 100 was moved by the user pushing dolly 190, but in Embodiment 2, asset management map generation device 100a is an autonomously traveling robot that travels autonomously over the predetermined floor.

Although basically the same processing as that in the flowchart illustrated in FIG. 5 is performed, Embodiment 2 differs from Embodiment 1 in that obstruction sensor 150 detects an obstruction that may interfere with the travel of asset management map generation device 100a and travels so as to avoid the obstruction. Here, the obstruction is an object that is difficult to detect using position sensor 102, such as the legs of a chair, an object that has fallen onto the floor, or the like, for example.

Upon accepting an instruction to start generating an asset management map (S01), asset management map generation device 100a outputs an instruction to start sensing to position sensor 102, imager 105, and obstruction sensor 150, and starts obtaining the sensing data (S02). Then, if, while the processing of steps S03 to S10 is being performed, an obstruction is detected in the direction of travel (referred to as “in front of”) of asset management map generation device 100a based on the sensing data obtained by obstruction sensor 150, obstruction position calculator 172 calculates the relative position of the obstruction with respect to obstruction sensor 150, and calculates the position of the obstruction on the floor map based on the floor map, the self position, and the relative position.

Travel plan generator 171 generates a travel plan for traveling while avoiding the obstruction, based on the floor map, the self position, and the position of the obstruction.

Upon obtaining the travel plan, travel controller 173 controls travel mechanism 160 in accordance with the obtained travel plan.

As described above, asset management map generation device 100a can detect an obstruction present in the travel direction (in front) of main body 101, and travel across the predetermined floor autonomously while avoiding the obstruction.

### 3. Effects, etc.

As described above, in management system 400a according to Embodiment 2, asset management map generation device 100a is capable of traveling autonomously, and can avoid obstructions when such obstructions are detected, which makes it possible to lighten the burden on the user for generating the asset management map.

### Embodiment 3

A management system according to Embodiment 3 will be described next. In Embodiment 1, asset management map generation device 100 generated the asset management map based on sensing data obtained by position sensor 102 and imager 104 provided in main body 101. In Embodiment 3, asset management map may be generated based on sensing data obtained by a position sensor and an imager provided in the information terminal. The following descriptions will focus on points different from Embodiment 1, and descriptions of redundant content will be omitted or simplified.

### 1. Configuration

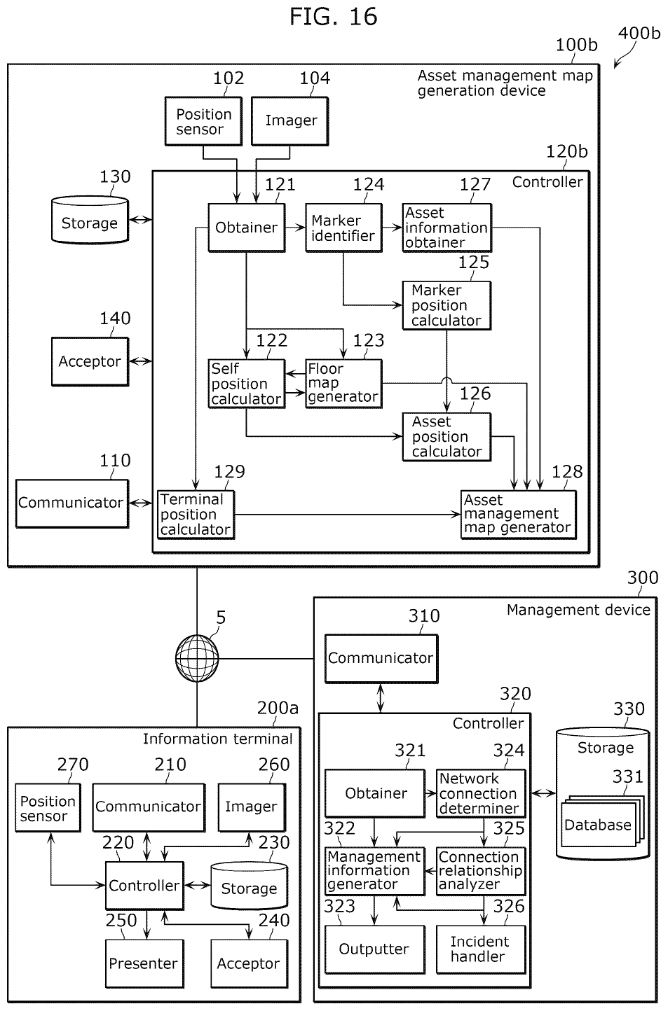

FIG. 16 is a block diagram illustrating an example of the functional configuration of the management system according to Embodiment 3. In FIG. 16, constituent elements that are the same as those illustrated in FIG. 2 are given the same reference signs.

As illustrated in FIG. 16, management system 400b according to Embodiment 3 includes, for example, asset management map generation device 100b, information terminal 200a, and management device 300. Each constituent element will be described hereinafter.

### 1-1. Asset Management Map Generation Device

Asset management map generation device 100b differs from asset management map generation device 100 according to Embodiment 1 in that terminal position calculator 129 is further provided.

### Controller

Controller 120b includes terminal position calculator 129 in addition to the configuration of controller 120.

Terminal position calculator 129 obtains a positional relationship between an object in the periphery and position sensor 270 of information terminal 200a, obtained by position sensor 270, generates a floor map related to the surrounding environment of information terminal 200a based on the obtained positional relationship using SLAM technology, for example, and calculates a self position, which is the position of information terminal 200a on the generated floor map (i.e., a terminal position). Specifically, the position of information terminal 200a is calculated in time series at the same time as the floor map is generated through SLAM using LiDAR as described in International Publication WO 2020/026294 (PTL 4), and pairs of times and positions are stored in storage 130 (more specifically, timestamps are added to the calculated positions).

### 1-2. Information Terminal

Information terminal 200a differs from information terminal 200 according to Embodiment 1 in that position sensor 270 is further provided.

Position sensor 270 detects an object in the periphery of itself, and obtains a positional relationship between the object and itself. Position sensor 270 is LiDAR, for example.

Controller 220 outputs the positional relationship obtained by position sensor 270 to asset management map generation device 100b through communicator 210.

### 2. Operations

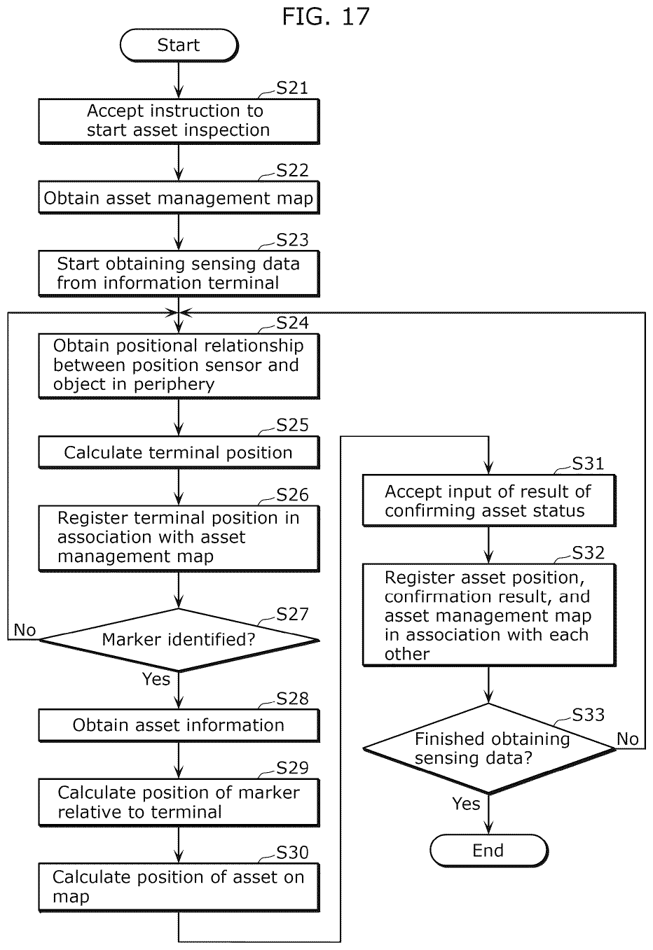

Operations by management system 400b according to Embodiment 3 will be described next with reference to the drawings. FIG. 17 is a flowchart illustrating an example of operations by management system 400b according to Embodiment 3. An example of operations performed when inspecting a plurality of assets 1 installed on a predetermined floor, for example, will be described here.

First, when acceptor 240 of information terminal 200a accepts an instruction to start inspecting asset 1 (S21), controller 220 of information terminal 200a outputs the instruction to asset management map generation device 100b through communicator 210 (not shown).

Upon obtaining the instruction, controller 120b of asset management map generation device 100b outputs a response signal to information terminal 200a through communicator 110 (not shown), and obtains the asset management map of the predetermined floor (S22). At this time, controller 120b of asset management map generation device 100b may obtain the asset management map by reading out an asset management map stored in storage 130, or may output a request signal for the asset management map to management device 300 and obtain an asset management map stored in database 331 of management device 300.

Upon obtaining the response signal from asset management map generation device 100b, controller 220 of information terminal 200a outputs an instruction to start obtaining the sensing data to position sensor 270 and imager 260 (not shown), and starts obtaining the sensing data (e.g., the positional relationship, the image information, and the like) from information terminal 200a (S23).

Upon obtaining the instruction to start obtaining the sensing data from controller 220, position sensor 270 detects an object in the periphery of itself and obtains a positional relationship of the object in the periphery relative to itself (not shown). Then, upon obtaining the positional relationship obtained by position sensor 270, controller 220 of information terminal 200a outputs the positional relationship to asset management map generation device 100b through communicator 210 (not shown). Additionally, imager 260 captures an image in the periphery of itself. The image may be a single image, or a moving image. Controller 220 outputs the image information obtained by imager 260 to asset management map generation device 100b through communicator 210 every predetermined length of time (not shown).

Upon obtaining the positional relationship of the object in the periphery with respect to position sensor 270 through communicator 110 (S24), obtainer 121 of asset management map generation device 100b outputs the obtained positional relationship to terminal position calculator 129 (not shown).

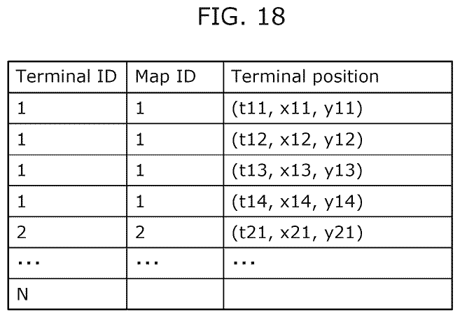

Terminal position calculator 129 calculates the terminal position (and more specifically, the current position of information terminal 200a) based on the obtained positional relationship (S25). Terminal position calculator 129 registers the terminal position information indicating the calculated current position of the terminal in storage 130 in association with the asset management map (S26). FIG. 18 is a diagram illustrating an example of the terminal position information. As illustrated in FIG. 18, in the terminal position information, the terminal ID, the map ID, and coordinate information indicating the terminal position are associated with each other.

Marker identifier 124 determines whether to identify a marker in the image captured by imager 260 (S27), and if a marker is not to be identified in the image (No in S27), the sequence returns to step S24. On the other hand, if marker identifier 124 identifies a marker in the image (Yes in S27), asset information obtainer 127 obtains the asset information related to asset 1 to which the marker is attached, based on the identified marker (S28).

Marker position calculator 125 then calculates the relative position of the marker identified by marker identifier 124 relative to the self (here, imager 260) (S29). Although not illustrated, marker position calculator 125 adds a timestamp to the calculated relative position of the marker and stores the timestamp in storage 130 as well.

Next, asset position calculator 126 calculates the position of asset 1 on the floor map (also called a “map”) based on the positional relationship obtained in step S24, the terminal position calculated in step S25, and the relative position of the marker calculated in step S29 (S30).

When acceptor 240 of information terminal 200a accepts an input of a confirmation result for the status of asset 1 (S31), controller 220 outputs the accepted confirmation result to asset management map generation device 100b through communicator 210 (not shown). For example, the confirmation result for the status of asset 1 is a result of confirming an operating state of asset 1, whether a physical or system defect is present, and the like. The confirmation result is output with a timestamp indicating the input date/time.

Upon obtaining the confirmation result for the status of asset 1 output from information terminal 200a (not shown), controller 120b of asset management map generation device 100b registers the position information indicating the position of asset 1 calculated in step S30, the confirmation result for the status of asset 1, and the asset management map in association with each other in a database (not shown) in storage 130 (S32).

Controller 120b determines whether the obtainment of the sensing data has ended (S33), and if the obtainment of the sensing data is determined not to have ended (No in S33), the sequence returns to step S24. On the other hand, if controller 120b determines that the obtainment of the sensing data has ended (Yes in S33), controller 120b transmits an inquiry signal, inquiring whether to end the operations, to information terminal 200a through communicator 110 (not shown).

When controller 220 of information terminal 200a receives the inquiry signal transmitted from asset management map generation device 100b through communicator 210, a notification for confirmation, such as “terminate the process?”, is presented in presenter 250 (not shown). Then, when acceptor 240 accepts a termination instruction, controller 220 outputs the termination instruction to asset management map generation device 100b through communicator 210 (not shown).

Upon obtaining the termination instruction through communicator 110, controller 120b of asset management map generation device 100b outputs inspection information, in which a movement trajectory of the terminal position and a confirmation result of the status of asset 1 (also called an “inspection result”) are associated with the asset management map, to information terminal 200a and management device 300 (not shown).

Upon obtaining the inspection information output from asset management map generation device 100b through communicator 210, controller 220 of information terminal 200a causes presenter 250 to present the inspection information (not shown).

Upon obtaining the inspection information output from asset management map generation device 100b, obtainer 321 of management device 300 stores the inspection information in database 331 (not shown).

When the data storage processing ends, management system 400b ends the operations.

Through this, management system 400b can inspect assets 1 registered in association with asset management map 30, and store the inspection information in asset management map 30, which makes it possible to centrally manage information related to the plurality of assets 1 installed in the building.

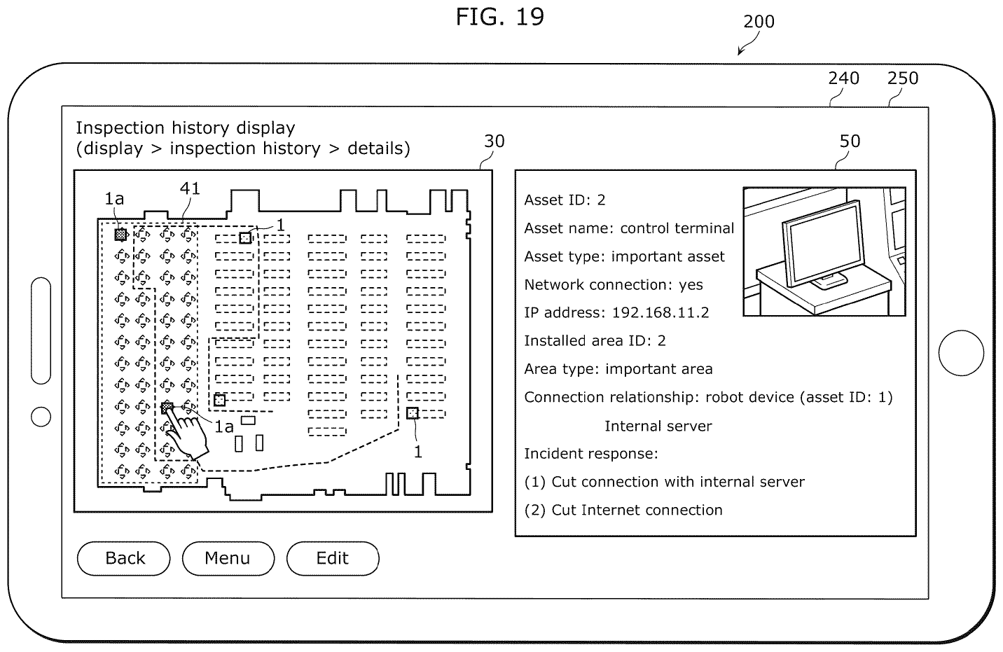

FIG. 19 is a diagram illustrating an example of the display of the inspection information. For example, as illustrated in FIG. 19, when the user causes presenter 250 (e.g., a monitor) of information terminal 200a, which is a personal computer, a tablet terminal, or the like, to display asset management map 30, the movement trajectory of information terminal 200a of the user (the bold broken line in the drawing) is displayed on asset management map 30. The movement trajectory of information terminal 200a may be displayed in presenter 250 after all inspection work by the user is complete. Through this, the user can easily grasp the inspected assets, inspection routes, and the like by confirming the movement trajectory displayed on asset management map 30. Additionally, presenter 250 may display the current terminal position and movement trajectory during the inspection work. This enables the user to proceed with the inspection work while confirming the current position.

Note that as illustrated in FIG. 19, when the user taps an icon of important asset 1a displayed on asset management map 30, registered information 50 of important asset 1a is displayed. The user may register a confirmation result, such as the operating state of important asset 1a, whether a physical or system defect has occurred, and the like, while performing the inspection work, for example. At this time, registered information 50 can be edited by tapping an edit button displayed on the screen and then tapping the icon of important asset 1a.

Here, the movement trajectory of the position of information terminal 200a held by the user appears on the asset management map. However, if the user performs an inspection while moving asset management map generation device 100 or 100a, the movement trajectory is the movement trajectory of asset management map generation device 100 or 100a.

### 3. Effects, etc.

As described above, in management system 400b according to Embodiment 3, when acceptor 240 accepts a display instruction to display a movement trajectory of the position of position sensor 270 on asset management map 30, presenter 250 may display the movement trajectory on asset management map 30 in accordance with the display instruction.

Through this, management system 400b can display the movement trajectory of the position of position sensor 270 in asset management map 30, which makes it possible to assist the user in visually confirming the status of an inspection of asset 1, for example.

### Other Embodiments

Although embodiments have been described thus far, the present disclosure is not limited to the foregoing embodiments.

For example, in Embodiment 1, asset management map generation device 100 includes position sensor 102 and imager 104, but position sensor 102 and imager 104 need not be provided. For example, asset management map generation device 100 may be an information processing device that includes the constituent elements other than position sensor 102 and imager 104. In this case, sensors including position sensor 102 and imager 104 may be mounted on dolly 190, and the data obtained by the sensors while moving over the predetermined floor may be output to the information processing device. Additionally, for example, the user may carry information terminal 200a including position sensor 270 and imager 260 while moving over the predetermined floor, and the data obtained by position sensor 270 and imager 260 during that movement may be output to the information processing device.

Although Embodiment 1 described an example in which the asset management map generated by asset management map generation device 100 was transmitted to information terminal 200 and management device 300 over network 5, for example, the configuration is not limited thereto. For example, asset management map generation device 100 may transmit the asset management map to information terminal 200 over network 5, and information terminal 200 may transmit the obtained asset management map to management device 300 over network 5. Note that network 5 is a wide-area communication network such as the Internet, but may instead be a local communication network such as Wi-Fi (registered trademark).

Additionally, for example, information terminal 200 and management device 300 may obtain the asset management map from a Universal Serial Bus (USB) memory or the like in which asset management maps generated by asset management map generation device 100 are stored.

Although Embodiment 2 described an example in which asset management map generation device 100a and management device 300 are separate devices, management device 300 may be incorporated into asset management map generation device 100a such that the devices are implemented as a single device, for example.

Although implemented by a plurality of devices in Embodiments 1 to 3, for example, the management system may instead be implemented as a single device. Additionally, if the system is implemented by a plurality of devices, the constituent elements provided in the management system may be distributed among the plurality of devices in any manner. Additionally, for example, a server device capable of communicating with the information terminal may include a plurality of the constituent elements of the management system.

Additionally, for example, although the foregoing embodiments described LiDAR as being used to generate the floor map, a rangefinding camera such as a Time of Flight (ToF) camera may be used instead.

For example, the method through which the devices communicate with each other in the foregoing embodiments is not particularly limited. Additionally, a relay device (not shown) may relay the communication among the devices.

Additionally, processing executed by a specific processing unit in the foregoing embodiments may be executed by a different processing unit. Additionally, the order of multiple processes may be changed, and multiple processes may be executed in parallel.

Additionally, in the foregoing embodiments, the constituent elements may be implemented by executing software programs corresponding to those constituent elements. Each constituent element may be realized by a program executing unit such as a CPU or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These aspects may also be implemented by any desired combination of systems, devices, methods, integrated circuits, computer programs, and computer-readable recording media.

For example, the present disclosure may be implemented as a travel control method executed by a computer such as the management system, or as a program for causing a computer to execute such a travel control method. The present disclosure may also be realized as a program for causing a general-purpose computer to operate as the management system according to the foregoing embodiment. The present disclosure may be implemented as a non-transitory computer-readable recording medium in which the program is recorded.

Additionally, embodiments achieved by one skilled in the art making various conceivable variations on the embodiments, embodiments achieved by combining constituent elements and functions from the embodiments as desired within a scope which does not depart from the spirit of the present disclosure, and the like are also included in the present disclosure.

### INDUSTRIAL APPLICABILITY

In the management system according to the present disclosure, the positions of assets are indicated on a floor map, and various types of information such as the positions of the assets indicated and asset information are registered in association with each other. As such, the management system can be widely used for centrally managing a plurality of assets in a building with ease.

1. A management system that centrally manages a plurality of assets provided in a building, the management system comprising:
a sensor that detects an object in a vicinity of the sensor and obtains a positional relationship between the sensor and the object;
a floor map generator that, based on the positional relationship obtained by the sensor, generates a floor map indicating a predetermined floor in the building;
a self position calculator that calculates a self position of the sensor on the floor map generated by the floor map generator;
a marker identifier that identifies a marker present in a vicinity of the sensor;
an asset information obtainer that, based on the marker identified by the marker identifier, obtains asset information related to an asset to which the marker is attached;
an asset position calculator that, based on the positional relationship, the self position, and a relative position of the marker with respect to the sensor, calculates a position of the asset on the floor map;
a database in which the floor map, the asset information, and the position information indicating the position of the asset are registered in association with each other;
an asset management map generator that, based on the database, generates an asset management map in which the position of the asset on the floor map is indicated, and in which the position of the asset indicated and the asset information are associated with each other;
a management information generator that generates management information related to management of the asset; and
a network connection determiner that determines whether the asset has a network connection function by using a network diagnostic tool,
wherein the management information generator:
obtains a determination result from the network connection determiner;
generates the management information based on the determination result obtained; and
registers the management information generated in the database in association with the asset management map.

2. The management system according to claim 1,
wherein the network diagnostic tool is a command-line tool.

3. The management system according to claim 2,
wherein the command-line tool is a ping command.

4. The management system according to claim 1,
wherein the management information generator generates the management information including a flag indicating whether the asset has the network connection function, based on the determination result obtained.

5. The management system according to claim 1,
wherein the marker includes an important asset marker indicating that the asset to which the marker is attached is an important asset,
the asset information obtainer obtains, as the asset information, information indicating that the asset has high managerial importance, when the marker identifier identifies the important asset marker, and
the asset having high managerial importance is at least one of an asset for which a state is to be confirmed preferentially, an asset for which taking stock or manufacturing progress is to be prioritized, or an asset for which operation is to be stopped preferentially.

6. The management system according to claim 1, further comprising:
a connection relationship analyzer that analyzes a connection relationship between the asset and an other asset based on the determination result,
wherein the connection relationship analyzer analyzes the connection relationship based on information indicating whether the asset and the other asset are components of a single system, whether the asset and the other asset are connected over an intranet, and whether the asset and the other asset are capable of accessing a predetermined network access point, and
the management information generator:
obtains an analysis result from the connection relationship analyzer; and
generates the management information based on the analysis result obtained.

7. The management system according to claim 6, further comprising:
an incident handler that, based on the analysis result, estimates an incident that can occur in the asset according to an attribute of the asset in the connection relationship with the other asset, and that determines a response procedure for the incident estimated,
wherein the management information generator:
obtains the response procedure determined by the incident handler; and
generates the management information based on the response procedure obtained.

8. The management system according to claim 6,
wherein the asset management map is divided into a plurality of areas,
the marker includes an important area marker indicating an area having high managerial importance, and
the management information generator:
obtains area information indicating that an area, among the plurality of areas, that includes the important area marker is the area having high managerial importance, when the marker identifier identifies the important area marker; and
generates the management information based on the area information obtained.

9. The management system according to claim 6, further comprising:
an acceptor that accepts an instruction from a user,
wherein when the acceptor accepts a modification instruction to modify at least one of the position information or the asset information of the asset, the management information generator updates the database by modifying at least one of the position information or the asset information of the asset registered in the database in accordance with the modification instruction.

10. The management system according to claim 9,
wherein when the acceptor accepts a modification instruction to modify the management information, the management information generator updates the database by modifying the management information registered in the database in accordance with the modification instruction.

11. The management system according to claim 9, further comprising:
a presenter that presents information to the user,
wherein when the acceptor accepts a presentation instruction to present the asset management map, the presenter presents the asset management map in accordance with the presentation instruction.

12. The management system according to claim 11,
wherein when the acceptor accepts a presentation instruction to present at least one of the asset information or the management information of an asset selected on the asset management map, the presenter presents the at least one of the asset information or the management information in accordance with the presentation instruction.

13. The management system according to claim 1, further comprising:
an acceptor that accepts an instruction from a user; and
a presenter that presents information to the user,
wherein when the acceptor accepts (i) a display instruction to display a movement trajectory of a position of the sensor on the asset management map and (ii) a confirmation result of confirming a status of the asset including an operating state of the asset and a confirmation result for a physical or a system defect, the presenter displays inspection information in which the movement trajectory on the asset management map and the confirmation result are associated with each other, in accordance with the display instruction.

14. A management method for centrally managing a plurality of assets provided in a building, the management method comprising:
detecting an object in a vicinity of a sensor and obtaining a positional relationship between the sensor and the object;
generating a floor map indicating a predetermined floor in the building, based on the positional relationship obtained in the obtaining;
calculating a self position of the sensor on the floor map generated in the generating;
identifying a marker present in a vicinity of the sensor;
obtaining asset information related to an asset to which the marker is attached, based on the marker identified in the identifying;
calculating a position of the asset on the floor map, based on a relative position of the marker with respect to the sensor;
registering the floor map, the asset information, and position information indicating a position of the asset in a database in association with each other;
generating an asset management map in which the position of the asset on the floor map is indicated, and in which the position of the asset indicated and the asset information are associated with each other, based on the database;
generating management information related to management of the asset; and
determining whether the asset has a network connection function by using a network diagnostic tool,
wherein the generating of the management information includes:
obtaining a determination result of the determining;
generating the management information based on the determination result obtained; and
registering the management information generated in the database in association with the asset management map.

15. A non-transitory computer-readable recording medium having recorded thereon a program for causing a computer to execute the management method according to claim 14.
